(19) United States
(12) Patent Application Publication
(10) Pub. No.: US 2003/0222253 A1
(43) Pub. Date: Dec. 4, 2003

(54) Fence post assembly, portable fencing system and method

(76) Inventors: Ronald H. Langlie, Ellendale, MN (US); James B. Easley, Orono, MN (US); Timothy N. Wilson, Blooming Prairie, MN (US)

Correspondence Address: INTELLECTUAL PROPERTY GROUP, FREDRIKSON & BYRON, P.A., 4000 PILLSBURY CENTER, 200 SOUTH SIXTH STREET, MINNEAPOLIS, MN, 55402, US

(21) Appl. No.: 10/354,918

(22) Filed: Jan. 30, 2003

Related U.S. Application Data
(63) Continuation-in-part of application No. 10/105,024, filed on Mar. 22, 2002.
Application No. 10/105,024 is a continuation-in-part of application No. 09/672,550, filed on Sep. 28, 2000, now Pat. No. 6,595,496.

(51) Int. Cl. H05C 1/00; A01K 3/00

(52) U.S. Cl. 256/10

(57) ABSTRACT

A fence post assembly, as well as a fencing system and related method utilizing the fence post assembly, for forming a temporary enclosure, such as a horse corral for restraining horses. The fence post assembly is provided with an extensible and retractable fence strand, such as polytape or wire, as well as a ground anchor at one end of the post to enable the post to be anchored into the ground. The extendable and retractable fence strand is selectively positionable along the length of the post between the first and second opposite ends thereof. In addition, the fence strand can be electrically conductive to permit the enclosure to be electrified. Provision is made to maintain electrical continuity between fence strands.

### CROSS-REFERENCE TO RELATED APPLICATIONS

This application is a continuation-in-part of application Ser. No. 10/105,024, filed on Mar. 22, 2002, which, in turn, was a continuation-in-part of application Ser. No. 09/672,550, filed on Sep. 28, 2000. This application claims priority to and incorporates by reference the entire contents of the previously mentioned applications herein.

### FIELD OF THE INVENTION

The present invention relates to a fence post assembly for use in a portable fencing system and related method. The fence post assembly of the invention is particularly suited for use in forming a variety of animal enclosures, such as a portable horse corral and the like. However, the fence post assembly, fencing system and method also have utility in forming other types of enclosures or in defining other bounded areas.

### BACKGROUND OF THE INVENTION

Often times it is necessary to define a temporary enclosure or bounded area in a location that does not have an existing enclosure(s) or in which one or more additional enclosures are necessary. One example of a situation in which such a need arises is when one or more horses are brought to a location not having existing enclosures or where the existing enclosures are inadequate and must be supplemented by temporary enclosures. Rodeos, horse shows, and temporary training and/or grazing sites are examples of locations at which a temporary enclosure(s) may be necessary. Previously, when a temporary enclosure was needed, such as for one or more horses, metallic fencing sections were generally hauled to the appropriate site and assembled to form an enclosure or horse corral. Typically, the fencing sections are heavy and difficult to assemble into a complete enclosure, as well as being hard to transport due to their weight and size. In addition, an enclosure made from metallic fencing can often be considered excessive when it is realized that an enclosure made from simpler components can adequately perform the intended function.

Therefore a need exists for an improved fencing system for use in forming a temporary enclosure or bounded area.

### SUMMARY OF THE INVENTION

The general purpose of the present invention is to provide an improved fence post assembly, as well as a fencing system and related method utilizing the improved fence post assembly, for forming a temporary enclosure, such as a horse corral for restraining horses. The fence post assembly is provided with an extensible and retractable fence strand, such as polytape or wire, as well as a ground anchor at one end of the fence post to enable the fence post to be anchored into the ground.

According to one aspect of the invention as defined in the claims, a fence post assembly is provided that comprises a fence post having first and second opposite ends, a ground anchor connected to the fence post adjacent the first end for anchoring the fence post, and a fence strand assembly connected to the fence post. The fence strand assembly includes an extendable and retractable fence strand, and the extendable and retractable fence strand is selectively positionable along the length of the fence post between the first and second opposite ends thereof.

According to another aspect of the invention as defined in the claims, a portable fencing system for forming an enclosure is provided that comprises at least one fence post assembly, with the at least one fence post assembly including: a fence post having first and second opposite ends, a ground anchor connected to the fence post adjacent the first end for anchoring the post; and a fence strand assembly connected to the post. The fence strand assembly includes an extendable and retractable fence strand, and the extendable and retractable fence strand is selectively positionable along the length of the fence post between the first and second opposite ends thereof. In yet another aspect of the invention, a method of forming an enclosure comprises providing a first fence post assembly having a fence post with first and second opposite ends, a ground anchor connected to the fence post adjacent the first end for anchoring the post and a fence strand assembly connected to the post. The fence strand assembly includes an extendable and retractable fence strand, and the extendable and retractable fence strand is selectively positionable along the length of the post between the first and second opposite ends thereof. The method further includes anchoring the fence post to the ground, extending the fence strand a sufficient amount to at least partially form an enclosure; and positioning the fence strand along the length of the fence post to achieve the desired fence strand height. In still another aspect of the invention, as defined in the claims, a fence strand assembly for a fence post is provided. The fence strand assembly includes a housing that includes a clamp assembly configured for releasable engagement with the fence post whereby the housing can be connected to and selectively positioned along the fence post. In addition, a fence strand material is at least partially disposed within the housing, with the fence strand material being extendable and retractable relative to the housing. Another aspect of the invention, as defined in the claims, provides a fencing kit that comprises a plurality of fence post assemblies. Each fence post assembly includes a fence post, a ground anchor for anchoring the post, and a fence strand assembly. The fence strand assembly includes an extendable and retractable fence strand, and means for selectively positioning the fence strand along the length of the post.

These and various other advantages and features of novelty which characterize the invention are pointed out with particularity in the claims annexed hereto and forming a part hereof. However, for a better understanding of the invention, its advantages and objects obtained by its use, reference should be made to the drawings which form a further part hereof, and to the accompanying description, in which there is described a preferred embodiment of the invention.

### BRIEF DESCRIPTION OF THE DRAWINGS

Referring to the drawings, wherein like numerals represent like parts throughout the several views:

FIG. 1 illustrates a fence post assembly in accordance with the 5 principles of the invention.

FIG. 2 is an exploded view of the components of the fence post assembly.

FIG. 3 is a top perspective view of the fence strand assembly used on the fence post assembly.

FIG. 3A is a side view of an interlocking cover positioned on a crank handle used on the fence strand assembly.

FIG. 3B is a bottom view of the interlocking cover used on the fence strand assembly.

FIG. 4 is a bottom perspective view of the fence strand assembly.

FIG. 5 illustrates the spindle used in the fence strand assembly.

FIGS. 6a and 6b are perspective views of the lock lever associated with the fence strand assembly.

FIG. 7 is a perspective view of the hook disposed at the end of the extensible/retractable fence strand.

FIG. 8 is a perspective view of the handle that is connected to the extensible/retractable fence strand.

FIG. 9 illustrates a plurality of the fence post assemblies forming an enclosure.

FIGS. 10A-C illustrate perspective, top and bottom views of the ground anchor.

FIG. 11 illustrates a fence strand assembly for use in an electric fence system.

FIG. 11A illustrates the bottom of the fence strand assembly in FIG. 11.

FIG. 12 illustrates a gate handle that is used to connect a bi-polar tape to an adjacent fence strand assembly.

FIGS. 12A-12D illustrate a gate handle that is used to connect a bi-polar tape to an adjacent fence strand assembly which includes a releasable locking latch.

FIGS. 13A-13D illustrate the two primary parts of the gate handle of FIG. 12.

FIG. 14 schematically illustrates the power supply and control used in the electric fence system.

FIG. 15 is a perspective view of an alternative embodiment of a ground anchor according to the invention.

FIG. 16 is cross sectional view taken through the center of the ground anchor of FIG. 15.

FIGS. 17A and 17B illustrate how the ground anchor cooperates with the post.

FIG. 18 illustrates a fence controller that is partially inserted within a post.

FIG. 19 illustrates a back side of the controller.

FIG. 20 is an exploded perspective view of the components of the controller.

FIGS. 20A and 20B is perspective view of the of the controller which includes an internal cover.

FIG. 21 is a perspective view of a cover that cooperates with the bottom of the housing to close the bottom of the housing.

FIG. 22 is a perspective view of an alternative embodiment of a lock lever.

FIGS. 22A and 22B are perspective views of an alternative embodiment of a lock lever and housing which include clamping projections.

### DETAILED DESCRIPTION

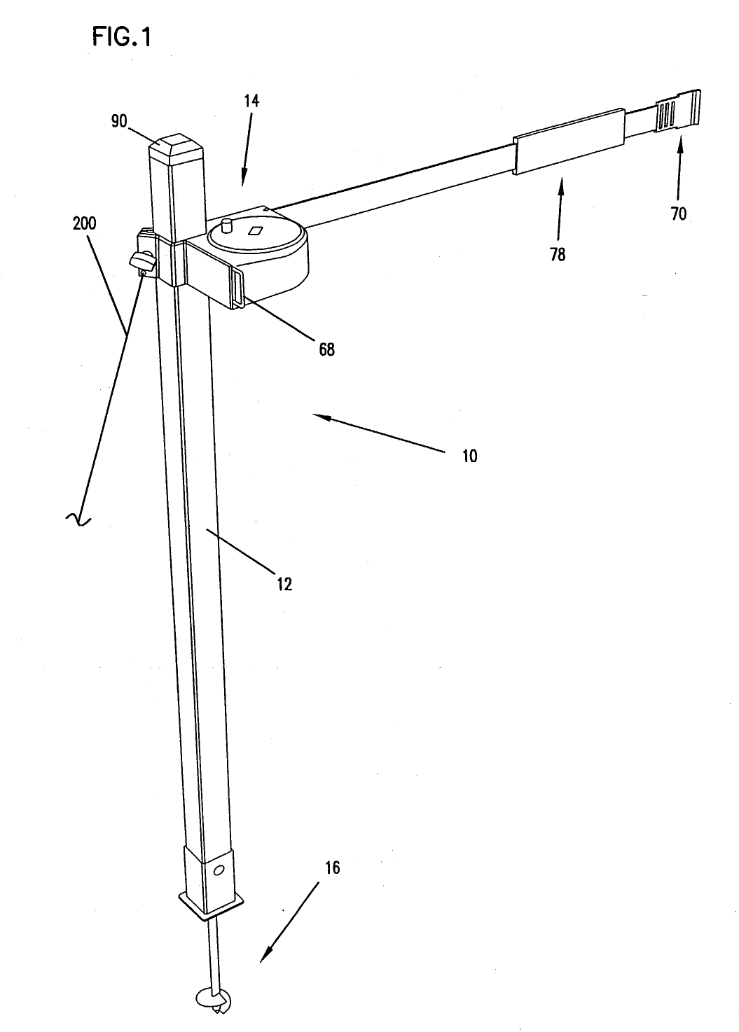

With reference to FIG. 1, a fence post assembly 10 in accordance with the principles of the present invention is illustrated. The fence post assembly 10 generally includes a fence post 12, a fence strand assembly 14 connected to the post 12 and adjustable along the length thereof, and a ground anchor 16 at one end of the post 12 to enable the post 12 to be anchored into the ground.

It is to be realized that although FIG. 1 illustrates the fence post assembly 10 as having a single fence strand assembly 14, multiple fence strand assemblies 14 can be connected to the post 12 to permit a multi-strand fence. In addition, multiple fence post assemblies 10 can be stacked together to provide a multi-strand fence. For instance, a second post 12 of a second fence post assembly 10 could be designed for securement to the end of a first post 12, such as by using removable fasteners such as screws, whereby the second post 12 is stacked on the first post 12 to increase the height of the resulting enclosure. The second fence post assembly 10 can include one or more fence strand assemblies 14, that cooperate with the one or more fence strand assemblies on the first post in defining the enclosure. For example, a two tiered fence post assembly could be designed having three fence strand assemblies 14 utilized on each stacked fence post, totaling a combined six fence strand assemblies 14 on the two-layer fence post assembly.

In certain embodiments of the invention, a power source is connected to each fence strand assembly 14 to energize the fence post assembly 10. The power source will generally be connected in parallel to the fence strand assembly 14 of the post assembly 10. For example, if there are multiple fence strand assemblies 14 connected to one post 12 and all the assemblies 14 are connected to a single power source and one of the assemblies 14 malfunctions, only that one assembly 14 that had a malfunction would be effected, and potentially, not be energized. In other words, the functioning of the one malfunctioning fence strand assembly 14 would not affect the normal functioning of the other fence strand assemblies, so long as the malfunction is not to the power source itself. Using the two tiered fence post assembly from above, if one of the fence strand assemblies 14 shorted out and no longer functioned electrically, the other five fence strand assemblies would still function regardless.

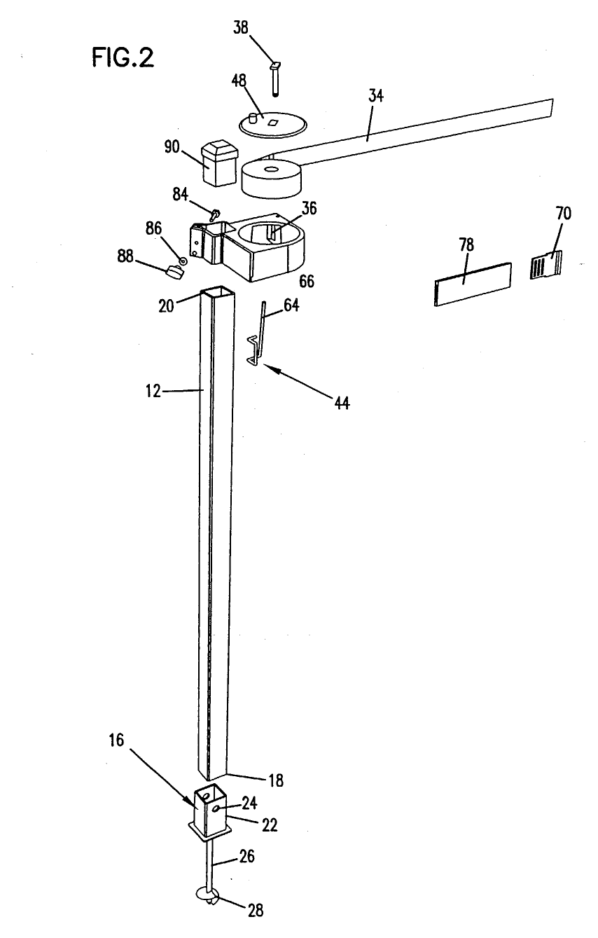

With continued reference to FIG. 1, as well as to FIG. 2, the post 12 has a generally elongated, hollow, rectangular shape with a first end 18 and a second end 20. The post 12 is made from suitable material, such as metal, plastic or fiberglass. The post 12 can have a cross-sectional shape other than rectangular, such as triangular or round, if desired. Further, it is also contemplated that, in certain embodiments, the post 12 could be made solid rather than hollow.

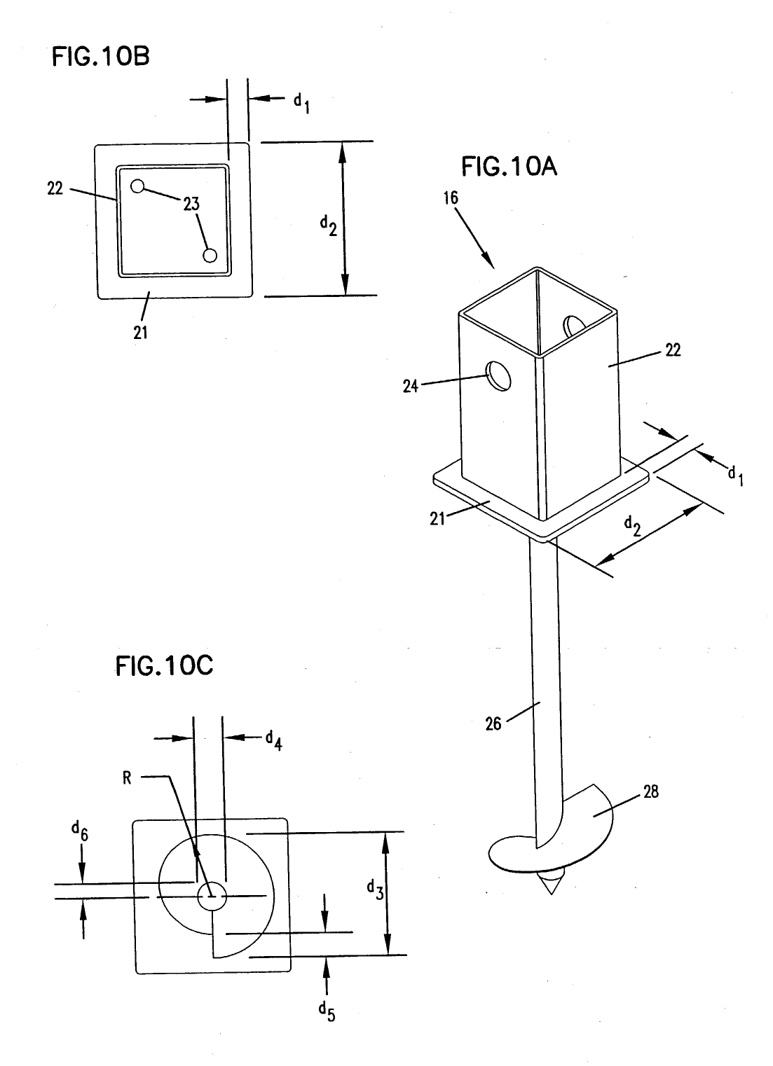

Connected adjacent to the first end 18 of the post 12 is the ground anchor 16. The ground anchor 16 is preferably made of metal, although plastic or fiberglass could be used as well. As best shown in FIGS. 2 and 10A, the ground anchor 16 includes a sleeve 22 that fits over the post 12 adjacent the first end 18. A pin, bolt, rivet or other suitable fastener (not shown) preferably extends through holes 24 provided in the sleeve 22 and through the post 12 in order to secure the ground anchor 16 to the post 12. Extending from the bottom of the sleeve 22 is a shaft 26 with an auger 28 disposed at the bottom end of the shaft 26. The auger 28 permits the post 12 to be screwed into the ground, thereby anchoring the fence post 10 into the ground. The ground anchor 16 could also be designed to fit within the end 18 of the post 12, rather than over the end 18 of the post 12. In one implementation, a shaft 26 having a length of about 8 to about 12 inches has been found to be effective. Other shaft lengths could be used if desired.

The details of an exemplary design of the ground anchor 16 are illustrated in FIGS. 10A-C. Between the bottom of the sleeve 22 and the shaft 26 is a plate 21. The plate 21 is designed to engage the ground when the anchor 16 is screwed into the ground, thereby providing stability to the post 12. As is evident from FIG. 10A, the plate 21 is preferably a square with sides having dimension d₂ so that the plate extends beyond the sides of the sleeve 22 a certain distance d₁ to provide the stabilizing effect. In one implementation, it has been found that a plate 21 having a dimension d₂ equaling about 3 inches, and a distance d₁ equaling about 0.5 inches, provides adequate stability. However, it is to be realized that other plate dimensions could be used as well.

To permit drainage of any moisture that may enter the post 12 or the sleeve 22, at least one, and preferably two or more, weep holes 23 are provided in the plate 21 as best seen in FIG. 10B. In addition, the auger 28 is designed to facilitate insertion into the ground. If the auger is too wide, it is difficult to screw the anchor into the ground. Therefore, the dimensions of the auger 28 are selected to facilitate insertion into the ground. By way of example, the auger 28 can have the following dimensions:

d₃—about 2.5 inches

d₄—about 0.5 inches

d₅—about 0.5 inches

d₆—about 0.25 inches

R—about 1.0 inch

about 0.666 threads per inch.

It is to be realized that the auger 28 can have other dimensions as well, without departing from the spirit and scope of the invention.

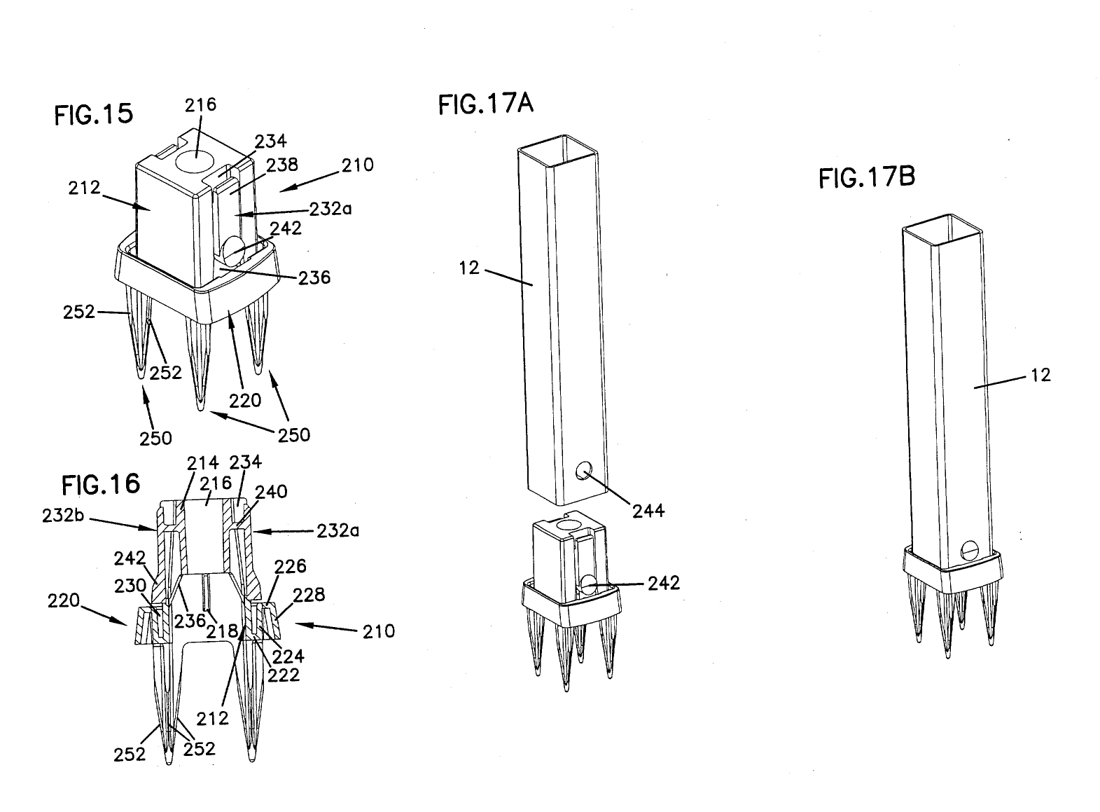

An alternate embodiment of a ground anchor 210 for anchoring the post 2 into the ground is illustrated in FIGS. 15-17. The anchor 210 is designed to releasably self-lock with the post 12 and permit manual disconnection of the anchor from the post. In this embodiment, the end of the post 12 that interacts with the anchor 10 must be hollow. The anchor 210 is preferably formed entirely from plastic, such as polycarbonate, acrylonitrile butadiene styrene (ABS) or other engineering grade plastics.

Referring to FIGS. 15-16, the anchor 210 comprises a central body 212 that is generally hollow and has a shape that generally matches the shape of the post 12 so that the central body 212 fits within the end of the post in close fitting relation therewith. The close fit between the body 212 and the interior of the post 12 secures the anchor and the post and prevents excessive relative movement therebetween. In the illustrated embodiment, the central body 212 is generally rectangular in shape so as to match the generally rectangular shape of the hollow end of the post 12. However, the central body 212 could have other shapes, such as circular or triangular, corresponding to the shape of the post that is used.

As shown in FIGS. 15 and 16, a cylindrical sleeve 214 through the center of the body 212 defines a passage 216. The passage 216 permits a spike or other similar supplemental anchoring member (not shown) to extend through the center of the anchor 210 and into the ground to supplement the anchoring action of the anchor 210.

A plurality of ribs 218 (only one rib 218 is visible in FIG. 16) extend between the exterior surface of the sleeve 214 and the interior surface of the body 212 to reinforce the sleeve 214.

Surrounding the exterior of the body 212 adjacent the base end thereof is a skirt 220. The skirt 220 includes a first flange portion 222 that extends outwardly from the body 212, an upwardly extending portion 224; a second flange portion 226 that extends outwardly from the end of the portion 224, and a downwardly extending portion 228. A groove 230 is defined between the exterior of the body 212, the flange portion 222 and the portion 224, which is angled slightly away from the exterior of the body 212. In use, the groove 230 receives the end of the post 12 therein, as is illustrated in FIG. 17B.

To releasably secure the post to the anchor 210, the anchor 210 is provided with a pair of integral locking members 232a, 232b. The locking members 232a, 232b are identical to each other, so the construction and operation of only the member 232a will be described in detail. Referring to FIGS. 15 and 16, it is seen that the exterior of the body 212 is formed with a channel 234 that receives the locking member 232a. In the illustrated embodiment, the channel 234 extends approximately the entire height of the portion of the body 212 that projects above the flange portion 226, with the sleeve 214 defining the rear of the channel 234 along the upper end, and with the portion of the channel 234 below the sleeve 214 opening into the interior of the body 210 via a passage 236.

The locking member 232a comprises a locking arm 238 that extends parallel to the channel 234, with the exterior surface of the arm 238 preferably being generally even or flush with the exterior surface of the body 212. The arm 238 is connected adjacent one end thereof to the sleeve 214 by a connector 240, whereby the arm 238 is cantilevered so as to permit the opposite end of the arm 238 to resiliently flex. The opposite end of the arm 238 is circular in shape and has an enlarged thickness compared to the remainder of the arm 238 (see FIG. 16) so as to form a lock button 42. The lock button 242 is sized to interact with an aperture 244 formed in the post 12 adjacent the bottom end thereof, whereby, in use, the button 242 fits into the aperture 244 when the post 12 and anchor 210 are engaged to lock the post to the anchor. The button 242 is generally tapered in thickness, with the thickness increasing from its juncture with the remainder of the arm 238 to the bottom end of the button 242. The tapering of the button 242 helps the post slide over the arm 232a as the post and anchor are being connected.

The anchor 210 further includes a plurality of integral ground engaging spikes 250 which, in use, are intended to be driven into the ground for anchoring the post. In the preferred embodiment, the anchor 210 includes four integral spikes 250. It is to be realized, however, that a larger or smaller number of spikes could be used. The spikes 250 extend from the bottom of the central body 212 at each corner thereof. Each spike 250 is formed from a plurality, preferably four, circumferentially even spaced ribs 252. The ribs 252 are tapered such that the spikes 250 taper from adjacent the body 212 to their distal ends. The tapering of the spikes 250 facilitates insertion of the spikes 250 into the ground, with the ribs 252 providing adequate securement once the spikes are driven into the ground. Further, as described above, a spike or other member, if desired, can be inserted through the passage 216 to supplement the spikes 250.

The locking members 232a, 232b are designed to releasably connect the post 12 to the anchor 210. With reference to FIGS. 17A and 17B, to connect the post and anchor, the end of the post is slid over the body 212 of the anchor, and into the groove 230 until the end of the post 12 engages the flange portion 222. During this time, the tapered buttons 242 are pushed inward by the post. When the apertures 244 become aligned with the buttons 242, the resilient return force of the arms 238 force the buttons 242 outward through the apertures 244, thereby locking the post and the anchor together. To release the post and anchor, the buttons 242, must be pushed inward to disengage from the apertures 244, at which point the post 12 and anchor 210 can be pulled apart.

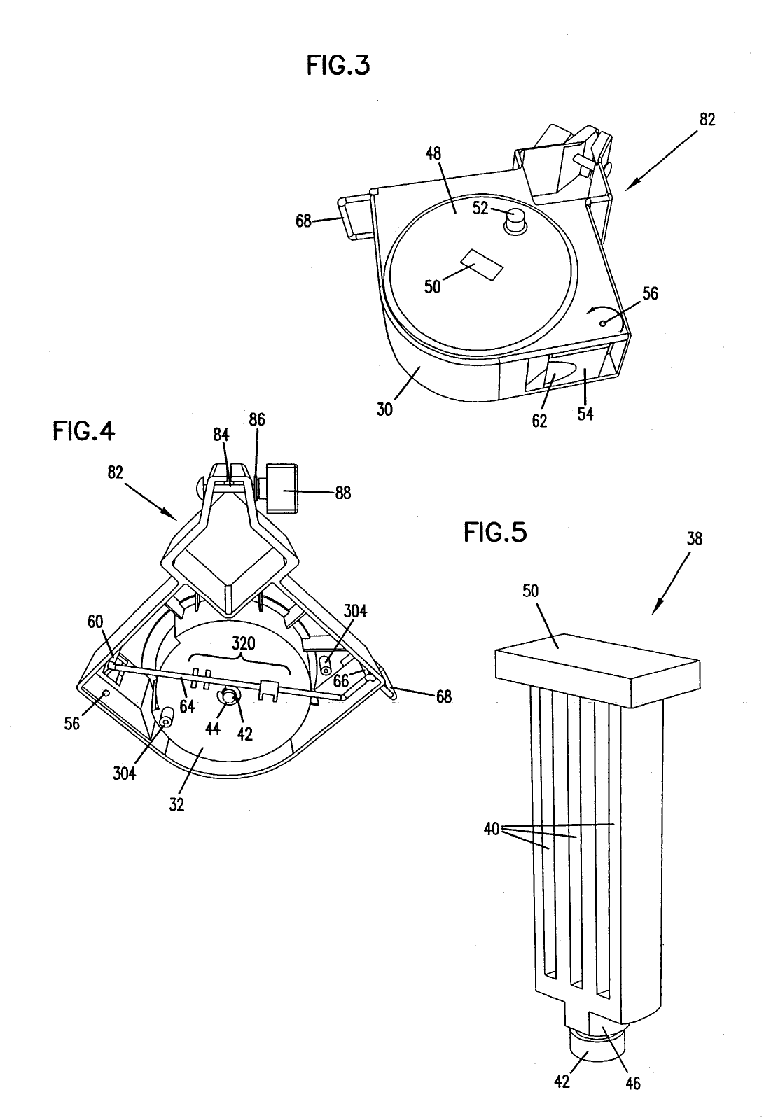

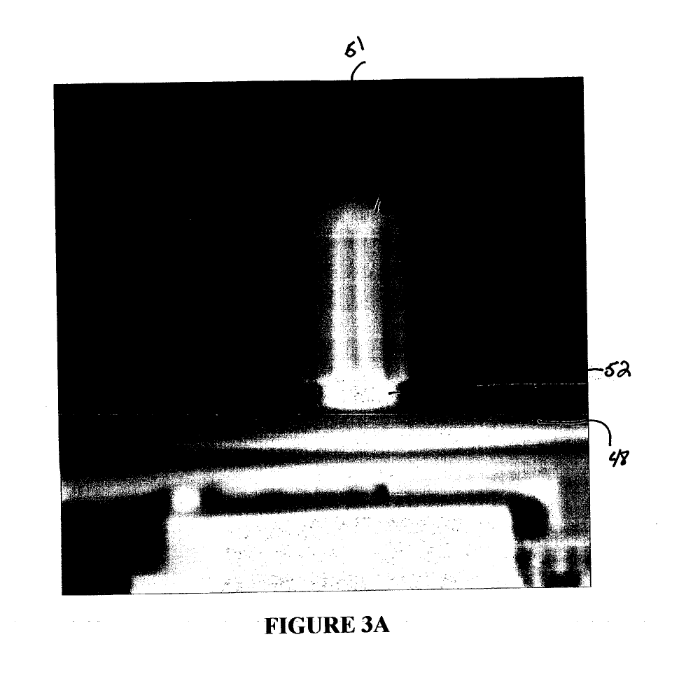

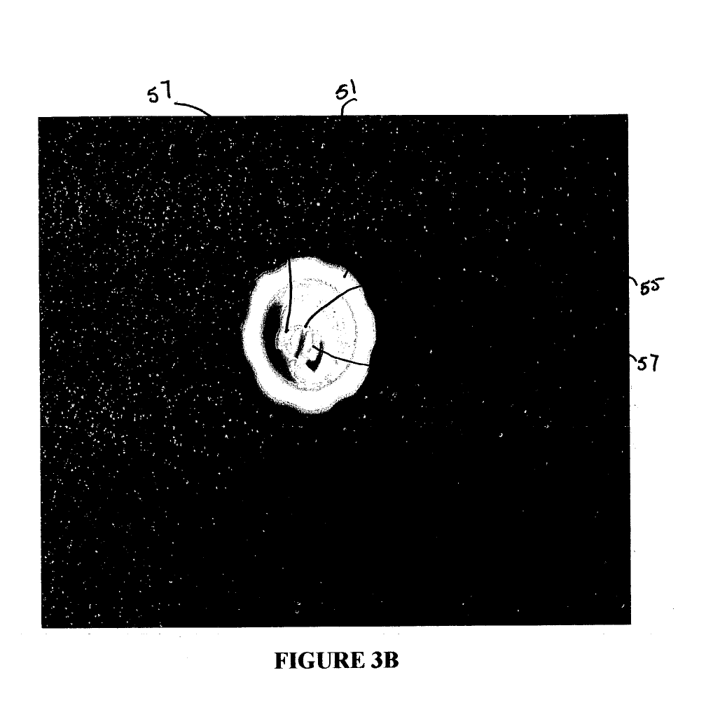

One embodiment of the fence strand assembly 14, best seen in FIGS. 2 and 3, includes a housing 30 that is slidably connected to the post 12 to permit adjustment of the housing 30 along the length of the post 12. The housing 30 is preferably formed from injection molded plastic, such as polycarbonate, acrylonitrile butadiene styrene (ABS) or other engineering grade plastics. However, in certain constructions such as a non-electric fence strand version, the housing or portions thereof could be formed from a metal material if desired.

Disposed within the housing 30 in a cup-shaped depression 32 thereof (best seen in FIG. 4) is a roll of fence strand material 34. The fence strand material 34 is illustrated in the figures as being a tape, such as polytape. However, it is to be recognized that other fence strand members, such as wire, rope and other slender fence strand members, could be used as well. In addition, as will be described in more detail later in the description, the fence strand material 34 can be electrified to provide an electric fence system.

One end of the fence strand material 34 extends through a slot 36 formed in the side of the housing 30, while the opposite end of the fence strand material 34 is secured to a spindle 38. The spindle 38, best seen in FIG. 5, includes a plurality of slots 40 therein through which the end of the fence strand material 34 extends such that rotation of the spindle in the appropriate direction causes the fence strand material 34 to be wound onto the spindle. The bottom end of the spindle 38 forms a pivot 42 which fits through a hole provided in the bottom of the cup-shaped depression 32 (see FIG. 4), with the spindle secured in place by a locking clip 44 engaging with a slot 46 in the pivot 42.

As shown in FIGS. 2-3, a spool 48 is rotatably received at the top of the housing 30 and closes off the cup-shaped depression 32 so that the roll of fence strand material 34 is enclosed within the housing. The spool 48 and housing 30 prevent ingress of water, dirt and other contaminants to the roll of fence strand material 34 thereby increasing the reliability and operational life of the fence strand assembly 14.

The spool 48 includes a hole therein that receives a correspondingly shaped head 50 on the spindle 38. As illustrated in the figures, the hole and head 50 are rectangular in shape, although it is to be realized that other shapes, such as triangular, pentagonal or the like, could be used.

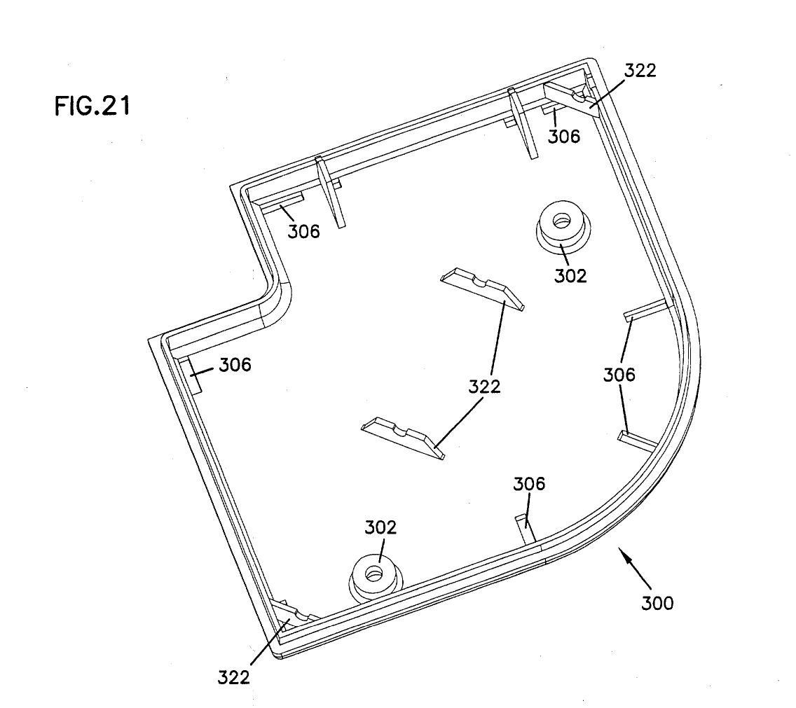

The housing 30 is illustrated in FIG. 4 as having an open bottom. However, the housing preferably cooperates with a housing cover 300, illustrated in FIG. 21, that closes the bottom of the housing 30. The housing cover 300 has a shape that is complementary to the shape of the open bottom of the housing 30, and is secured to the housing using screws that extend through bosses 302 on the cover 300 and into threaded boss 304 (shown in FIG. 4) formed on the housing 30. The cover 300 preferably includes a plurality of weep holes 306 to allow drainage of the interior of the housing 30.

As best seen in FIG. 3, a crank handle 52 is disposed on, formed on, or otherwise connected to the top surface of the spool 48. The crank handle 52 is sized and shaped so as to permit manual or mechanical rotation of the spool 48. Rotation of the spool 48 causes rotation of the spindle 38, due to the fit of the head 50 into the spool hole. Thus, the spool 48 can be rotated via the crank handle 52, thereby rotating the spindle 38, to either pay-out (i.e. extend) the fence strand material 34 or wind-up (i.e. retract) the fence strand material 34.

As mentioned above and illustrated in FIG. 3, a crank handle 52 is disposed on, formed on, or otherwise connected to the top surface of the spool. The crank handle 52 is sized and shaped so as to permit manual or mechanical rotation of the spool 48. In this embodiment, the crank handle 52 may be rigidly attached to the spool 48.

In an alternative embodiment, as depicted in FIG. 3A, an interlocking cover 51 can be utilized with the crank handle 52 to alleviate the problem of an operator's fingers losing their grip on the crank handle 52. As illustrated, the interlocking cover 51 is positioned on top of the crank handle 52, leaving a gap between the cover and the spool 48. With this gap, and by the design of the interlocking cover 51, the cover is enabled to spin on the crank handle 52. Thus, as the spool 48 is rotated, and the operator's hand becomes torqued to a point where his hand usually slips on the crank handle 52, the interlocking cover 51 will spin on the crank handle 52 instead. Thus, the operator will not lose his grip on the crank handle 52 when rotating, ensuring easier rotation of the spool 48 and less wear on the surface of the crank handle 52.

As illustrated in FIG. 3B, the interlocking cover 51 has a pair of centrally located internal stems 55. The stems 55 may be inserted in an aperture on the top end of the crank handle 52 when the cover 51 is assembled on to the crank handle. The stems 55 further have tabs 57 on their lower ends which facilitate the cover 51 to be interlocked with the crank handle 52, but still enable the cover to rotate on the handle.

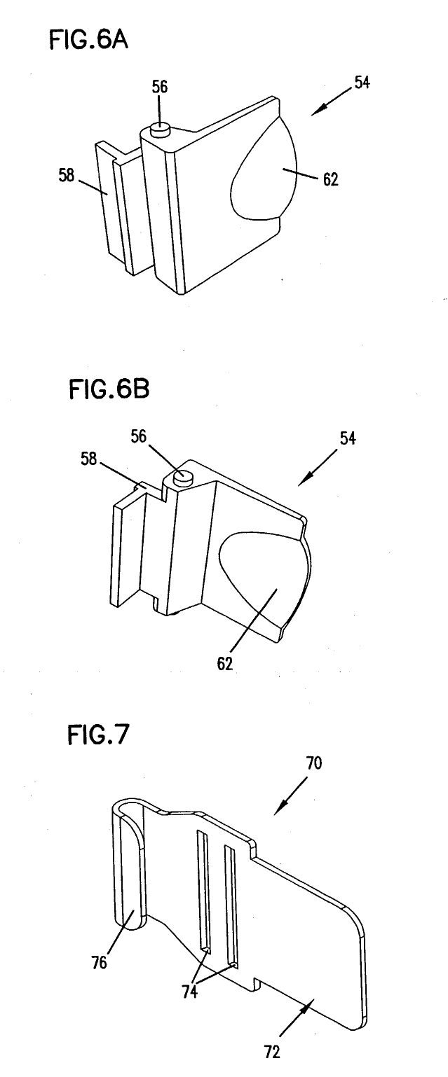

With reference to FIGS. 3, 4, 6a and 6b, a locking mechanism is preferably provided in order to lock the fence strand material 34 and prevent further retraction/extension of the fence strand material 34. The lock mechanism includes a lock lever 54 that is pivotally secured on the housing 30 adjacent the slot 36 to control ingress/egress of the fence strand material 34 through the slot 36. The lock lever 54 includes a pair of pivot pins 56 that snap fit into suitably provided holes in the housing 30. A clamp bar 58 formed on the lock lever 54 forcibly clamps the fence strand material 34 against a wire finger 60 (see FIG. 4) and against the housing 30, when the lock lever 54 is in the position shown in FIGS. 3 and 4, and prevents further ingress/egress of the fence strand material 34 through the slot 36. A scalloped depression 62 is formed on the lock lever 54 to permit a persons fingers) to get behind the lever to facilitate pivoting of the lever to an unlock position where the lever 54 projects from the outline of the housing 30.

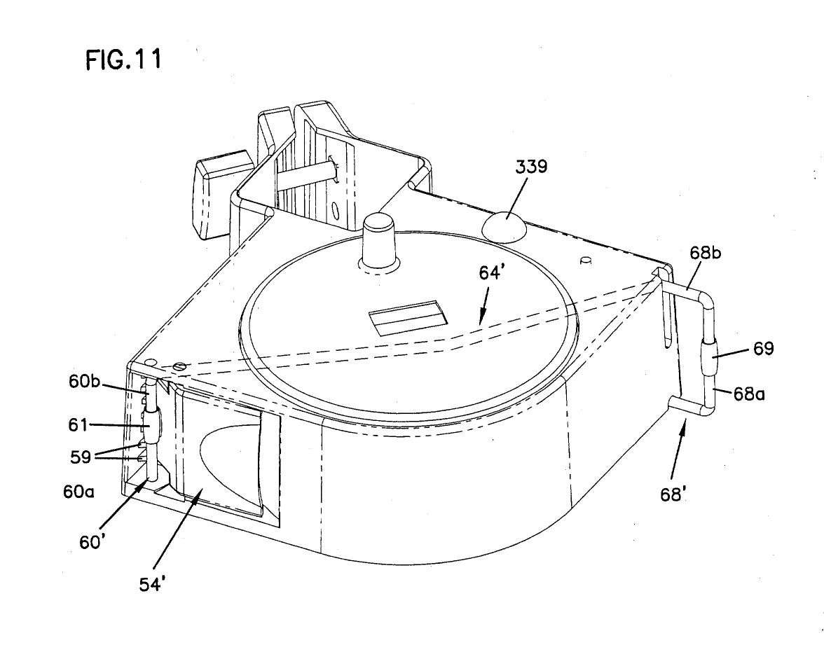

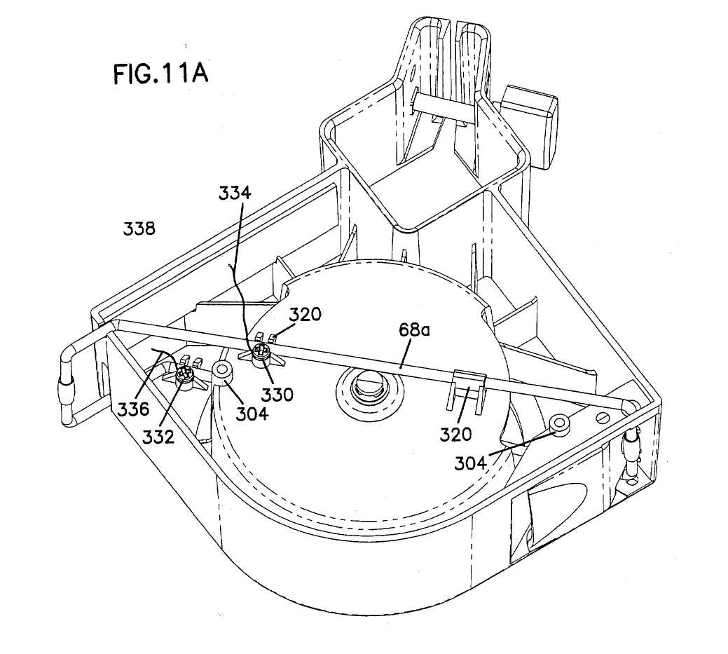

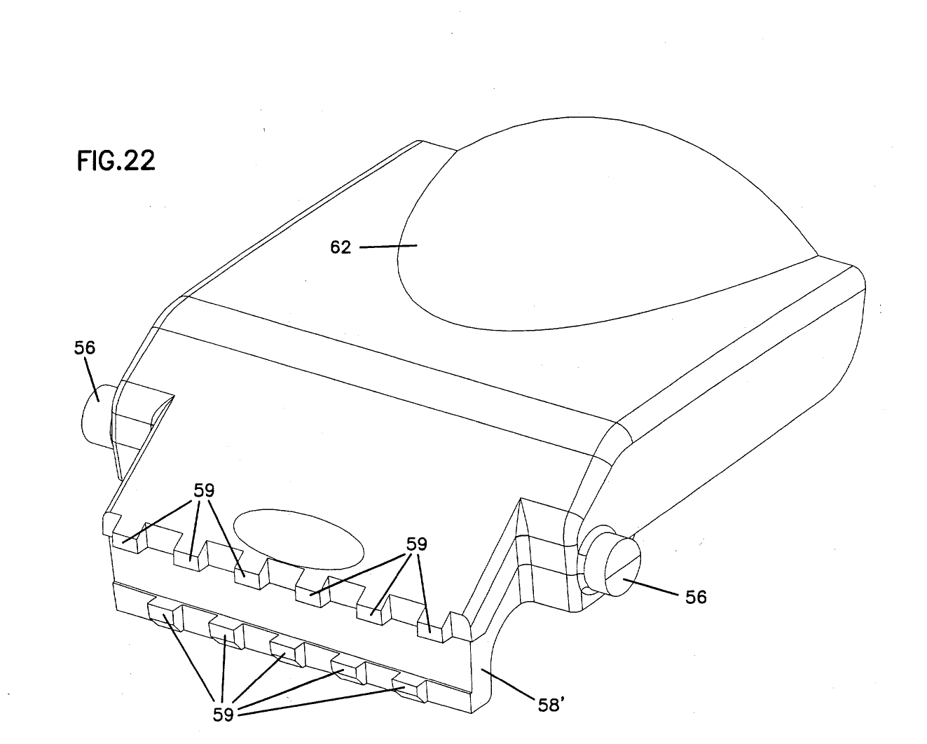

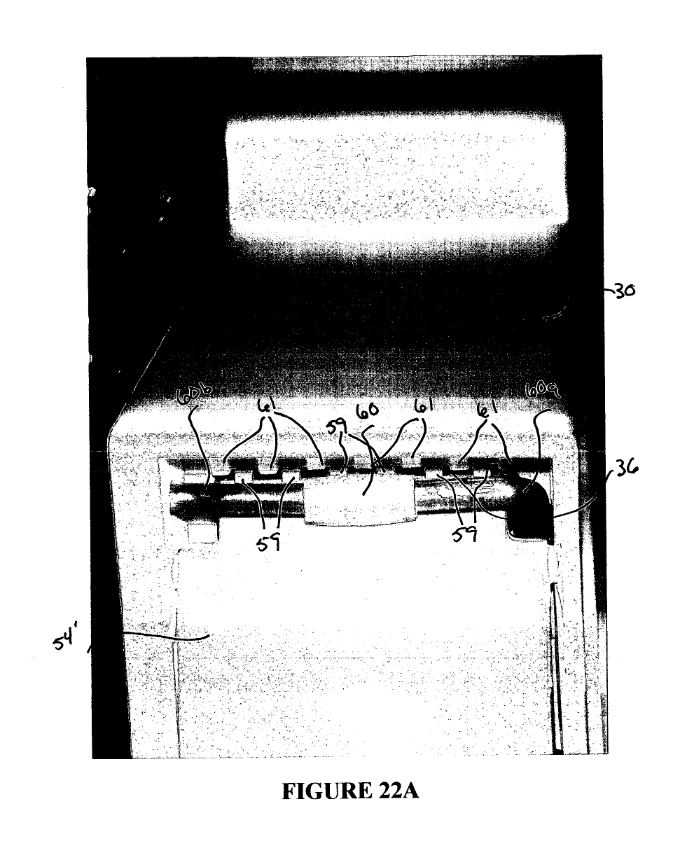

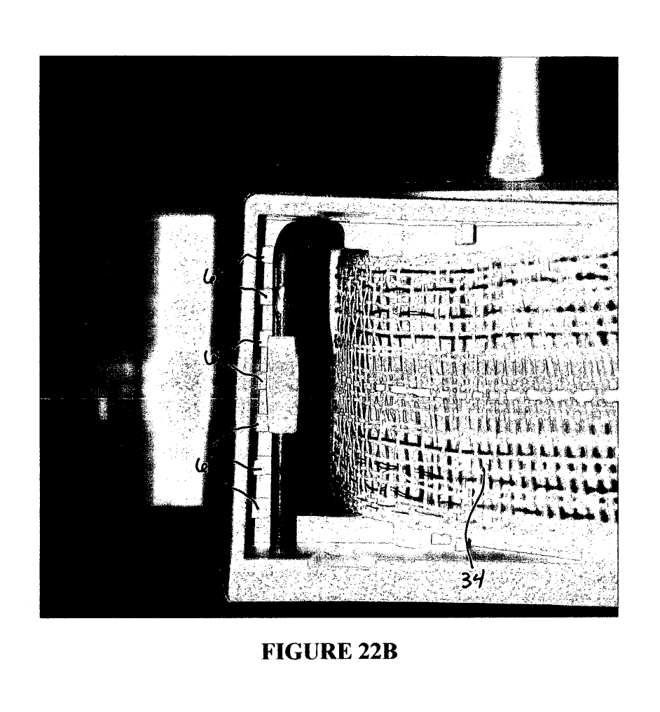

An alternate embodiment of a lock lever 54′ is illustrated in FIG. 22. The lock lever 54′, which is preferably used with the construction illustrated in FIG. 11, includes a plurality of projections 59 on the clamp bar 58′ to enhance the clamping action of the lock lever 54′. The projections 59 provide an improved electrical connection between the hot and ground wires in the tape 34 exiting the housing and the wires 60a and 60b. In certain alternate embodiments, there is an additional set of projections 61, illustrated in FIG. 22A, which are located on the inner side of the slot 36 of the housing 30 just positioned opposite the projections 59 on the lock lever 54′. The additional projections 61 are situated on the housing 30 such that they fall between the projections 59 on the lock lever 54′ when the lever 54′ is closed, providing a “jigsaw fit” of the projections 59 and 61, as illustrated in FIG. 22A. The consequence of the “jigsaw fit” between the two surfaces is that they work in combination to provide a solid secure grip on the tape 34 passed between the projections 59 and 61 and out of the slot 36 of the housing 30, as illustrated in FIG. 22B. In contrast, by simply using a solitary set of projections 59 on the lever 54′ as the only mechanism for securing the tape 34, there is still some chance for slippage or movement of the tape 34 between the projections 59 and the smooth inner wall of the housing 30.

The wire finger 60 discussed above forms one end of a wire 64 that extends beneath the cup-shaped depression 32 as best seen in FIG. 4. The opposite end of the wire 64 extends through a slot 66 in the housing 30 and forms a loop 68. The loop 68 permits connection of fence strand material 34 to the housing 30. As shown in FIG. 4, the housing 30, such as on the bottom of the cup-shaped depression 32, includes a plurality of wire supports 320 that holds and secure the wire 64. In addition, the housing cover 300 in FIG. 21 includes a plurality of wire supports 322 for holding and securing the wire 64 when the cover is mounted on the bottom of the housing 30.

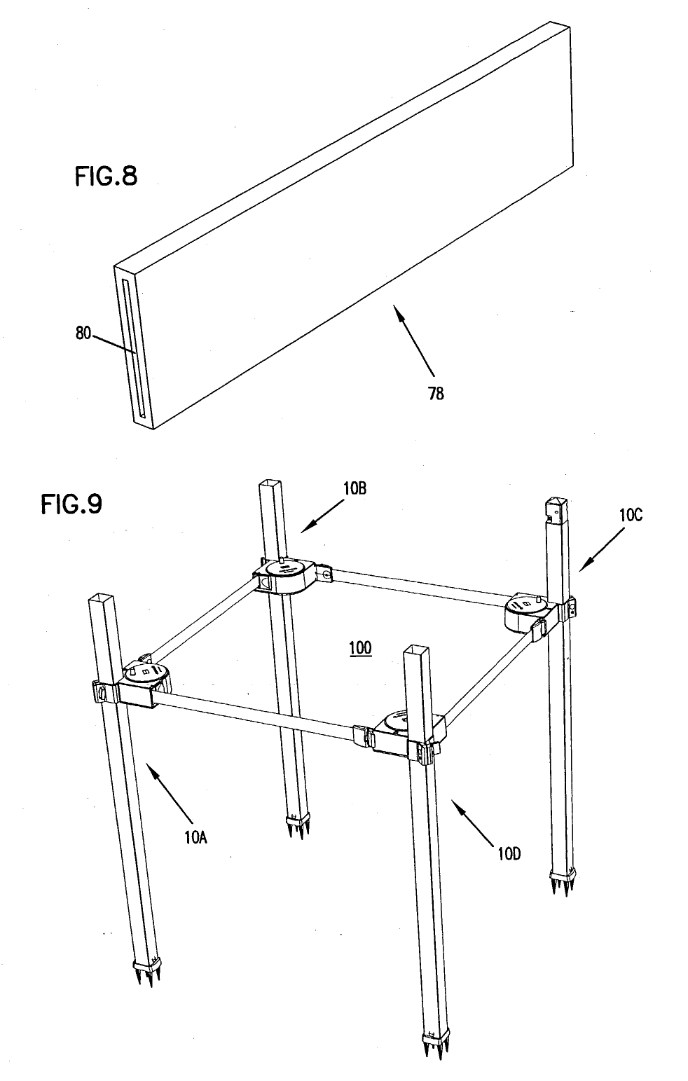

With reference now to FIGS. 1, 2 and 7, a strand connector 70 is connected to the end of the fence strand material 34. One embodiment of the strand connector 70 of the present invention is preferably formed from a metal, such as stainless steel, or from a suitable plastic material. The connector 70 includes a buckle end 72 provided with a series of slots 74 through which the end of the fence strand material 34 is woven like a buckle so that the end of the fence strand material and the connector 70 are securely fastened. The opposite end of the connector 70 is formed into a hook 76 which is intended to engage the loop 68 on the wire 64 to connect the end of the fence strand material 34 to an adjacent housing 30. The construction of the connector 70 is particularly suited for use with a tape, such as polytape, as the fence strand material. If the fence strand material 34 is slender, such as wire or rope, an alternate connector that is more suited for connection to a slender fence strand member, but which also is able to connect to the housing, could be used.

In certain electric fencing systems, the connector 70 would preferably be formed from metal so that electrical current is transferred from the fence strand material of one housing, through the connector 70 which connects to the loop 68 and into the wire 64 of an adjacent housing which carries the current across the adjacent housing to the finger 60 which in turn is in electrical contact with the fence strand material of the adjacent housing as a result of the clamping action provided by the lock lever 54. In this manner, electrical continuity can be maintained. When the fence is not electrified, the connector 70 can be either metal or plastic, and connects to the housing in the manner described or in any other suitable manner.

An optional embodiment of a strand connector 70 may be a gate handle 78, illustrated in FIGS. 1 and 8. The gate handle 78 can be provided to facilitate handling of the end of the fence strand material 34. When used, the gate handle 78 is preferably formed of extruded polyvinylchloride (PVC) or other suitable plastic, and includes a channel 80 formed therethrough. The fence strand material 34 slides through the channel 80 and the buckle end 72 of the connector 70 wedges tightly into the channel 80. Thus, when used, the gate handle 78 provides a convenient handle by which a user can grasp and hold the end of the fence strand material 34.

As mentioned, the fence strand assembly 14 is adjustable along the length of the post 12. To accomplish the adjustment, the housing 30 is provided with a clamp assembly 82 that defines a shape, corresponding to the shape of the post 12, to permit clamping engagement of the housing 30 with the post 12, as shown in FIGS. 1-4. The clamp assembly 82 includes a bolt 84, a washer 86 and a knob 88 that cooperate in a manner known in the art to tighten and loosen the clamp assembly 82. Through appropriate rotation of the knob 88, the clamp assembly 82 is loosened and the fence strand assembly 14 can be adjusted along the length of the post 12 to the desired height. Rotation of the knob 88 in the opposite direction tightens the clamp assembly 82 and locks the fence strand assembly 14 in position. As shown in FIGS. 1 and 2, a cap 90 fits into and closes off the second end 20 of the post 12. The cap could also fit over, rather than within, the second end of the post.

Although a clamp assembly 82 has been described herein as permitting adjustment of the housing 30, other means permitting adjustment of the housing 30 could be utilized as well. For instance, an indexing system including a plurality of indexing holes along the length of the post 12 and an indexing pin inserted through a portion of the housing 30 and into a selected one of the indexing holes could be used.

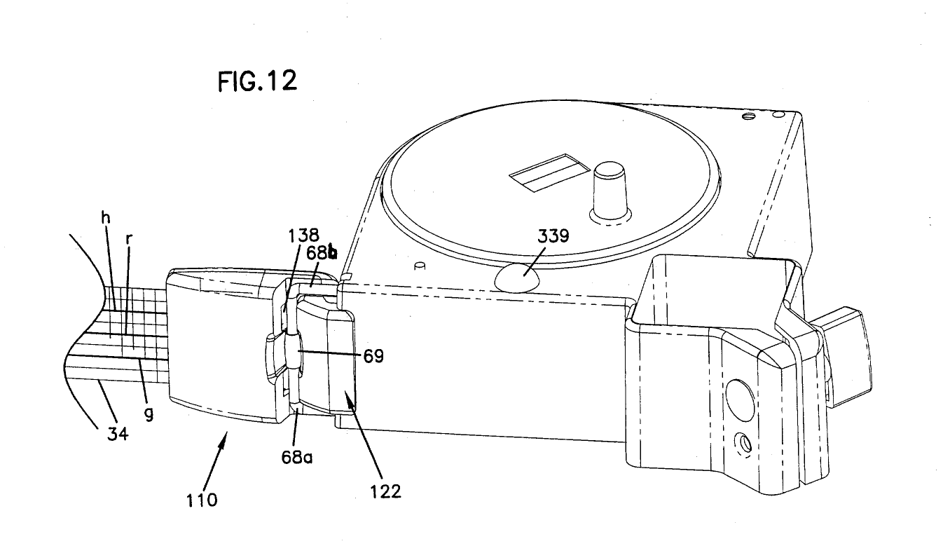

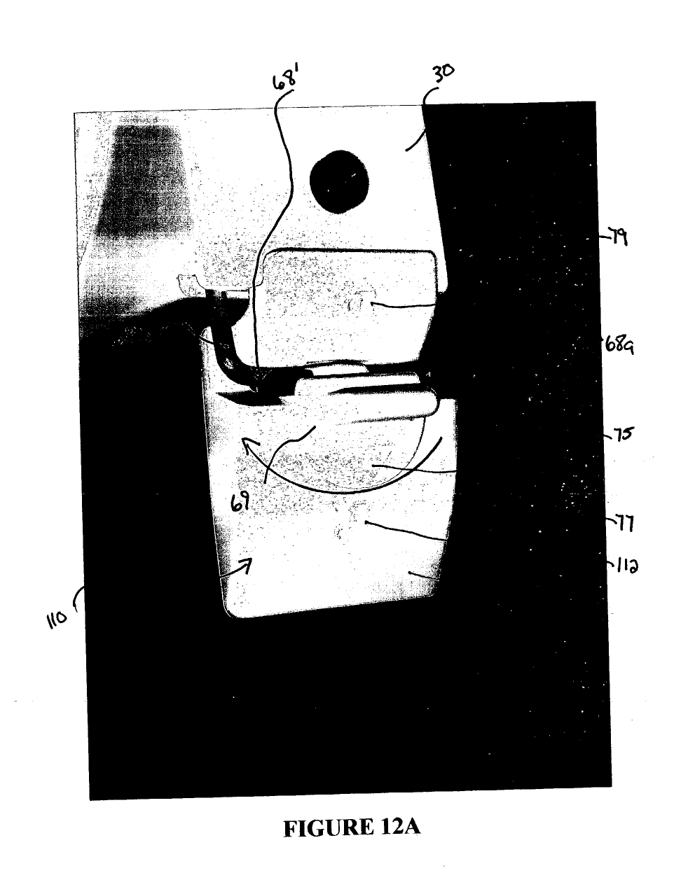

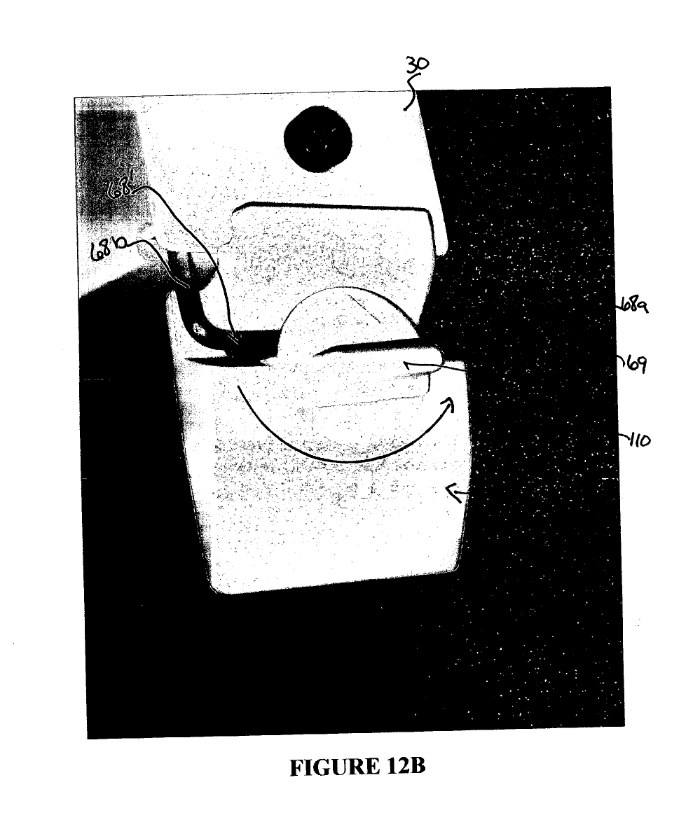

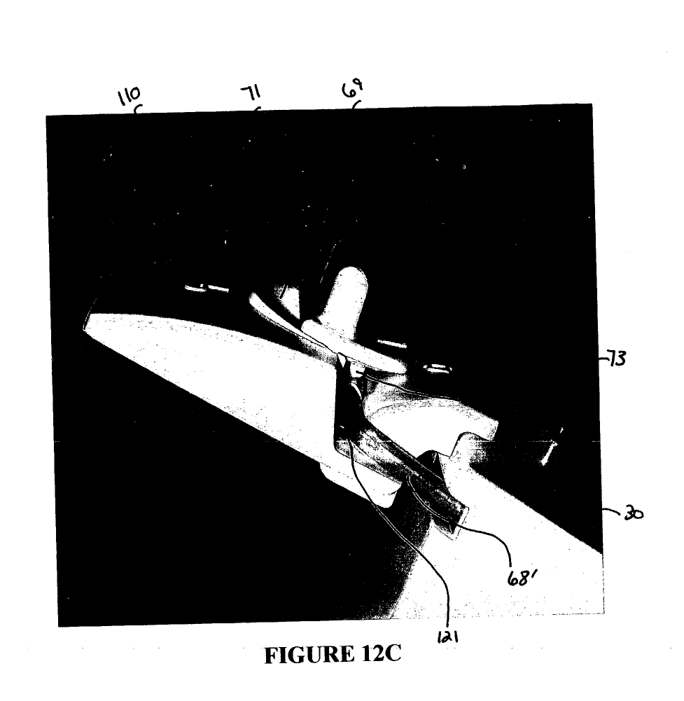

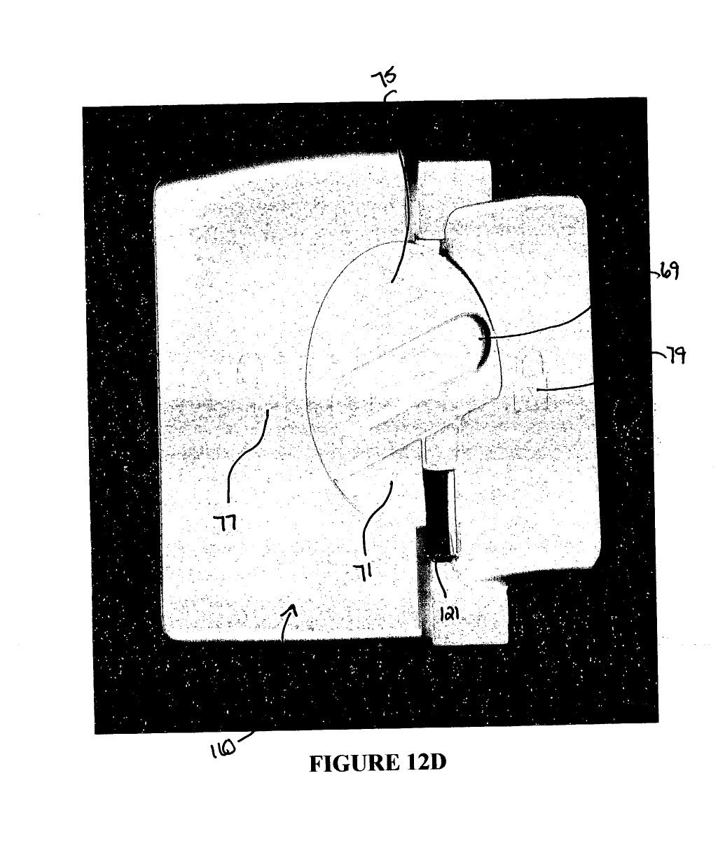

As described previously, the fence post assembly 10 can be used to form an electric fence or enclosure. In an electric fence version, the fence strand material 34 must be constructed so as to permit conduction of electricity. When the fence strand material 34 is a tape, as illustrated in the figures, the type of tape used can be a bi-polar tape. Bi-polar tapes, which are generally known in the art, include a hot wire(s) and a ground wire extending along the length thereof. The fence strand tape, for either nonelectric or electric uses, also preferably includes a reflective strand r extending through the center of the tape, as shown in FIG. 12, to indicate the presence of the tape at night when light reflects off of the reflective strand.

A conducting wire, rather than tape, can be used as the fence strand material 34 if desired. A suitable type of wire is polywire. The use of wire permits a longer length of fence strand material 34 to be used on the spool 48, as compared to using tape. By way of example, for the same size spool, it has been found that the length of the wire that can be used can be up to about four time greater than the length of the tape.

As discussed above, in an electric fence version, electrical continuity is required between a fence strand that connects to the housing 30 and the fence strand that exits the housing 30. As discussed for FIGS. 1-8, the wire 64 is one means that can be used to transfer electricity between fence strands. In this regard, the wire 64, which is made of metal or other conducting material, provides the necessary electrical path through the housing 30 which in this version is made from a non-conducting material such as plastic.

FIGS. 11-13 illustrate a construction that is designed for use when the fence strand material 34 is a bi-polar tape. Because bi-polar tape has ground and hot wires, the wire 64′ is constructed differently than the wire 64, in that the loop 68′ of the wire 64′ is provided with a plastic or other non-conducting piece 69 that divides the loop 68′ into separate wires 68a, 68b. One wire, for example bottom wire 68a, is designed to electrically connect to the hot wire(s) in the bi-polar tape, and runs under the cup shaped depression as shown in FIG. 11A. The other wire, for example top wire 68b, is designed to electrically connect to the ground wire(s) in the bi-polar tape, and runs through the housing, as shown in dashed lines in FIG. 11, without interfering with the rotation of the roll of bi-polar tape disposed in the housing. Likewise, the finger 60′ is also provided with a non-conducting piece 61 that divides the finger 60′ into separate wires 60a, 60b. The wire 60a is connected to the wire 68a via the portion that runs under the cup shaped depression, and the wire 60b is connected to the wire 68b as shown by the dashed lines in FIG. 11. Therefore, the wires 60a, 68a form a first electrical path through the housing while the wires 60b, 68b form a second electrical path. The non-conducting pieces 61, 69 separate the first and second electrical paths from each other.

As further illustrated in FIG. 11, the lock lever 54′ shown in FIGS. 22, 22A and 22B having the projections 59 may be used used. When the lock lever 54′ is pivoted to the clamping position, the projections 59 and 61 secure the tape in position and the projections 59 and end of the lock lever 54′ proximate to the slot 36 press the bi-polar tape against the wires 60a, 60b. The projections 59 and end of the lock lever 54′ provide an improved electrical connection between the hot and ground wires in the tape exiting the housing and the wires 60a, 60b.

In addition, as illustrated in FIG. 11A, screws 330, 332 are threaded into bosses disposed adjacent to the wires 68a, 68b, with the heads of the screws contacting the wires. Wire leads 334, 336 contact the screws 330, 332, respectively, and lead to a circuit board 338 located in the housing. In this manner, electricity can be supplied to the wire 64′ and to the tape. Moreover, as shown in FIGS. 11 and 12, the housing preferably includes a window 339 on the top surface thereof. A signal element, such as a light emitting diode or other illumination device, is disposed underneath the window 339 and is connected to the circuit board 338 so as to illuminate when electricity is provided to the wire 64′. The window 339 thus provides a readily visible indicator that the fence post assembly is powered, and that the fence strand material is electrified.

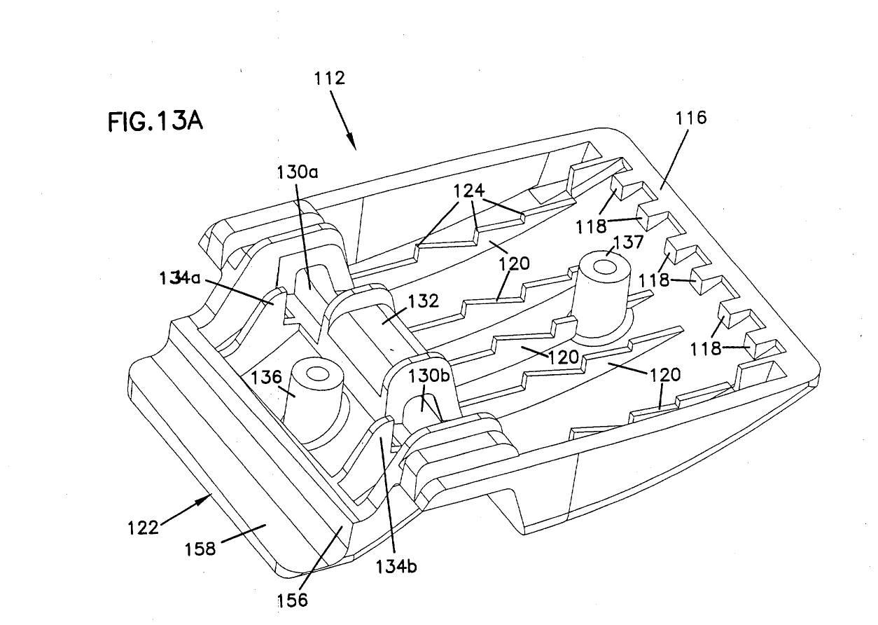

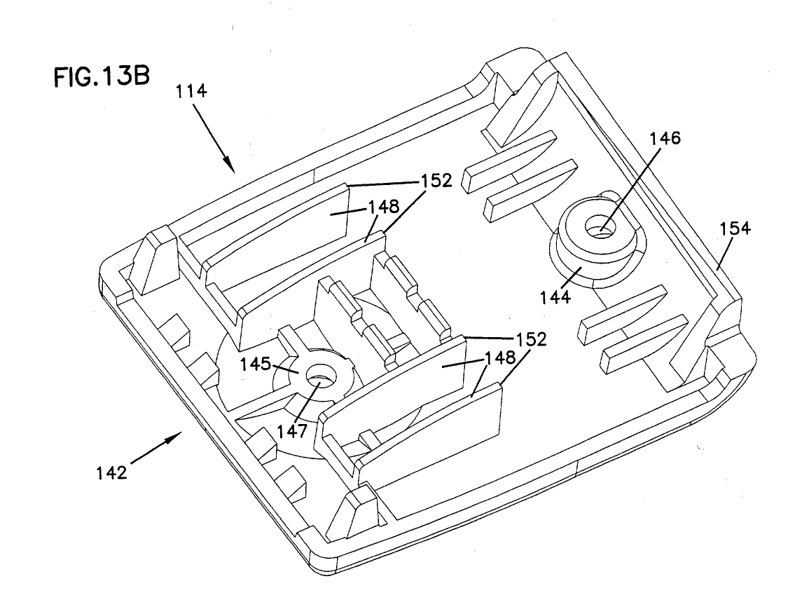

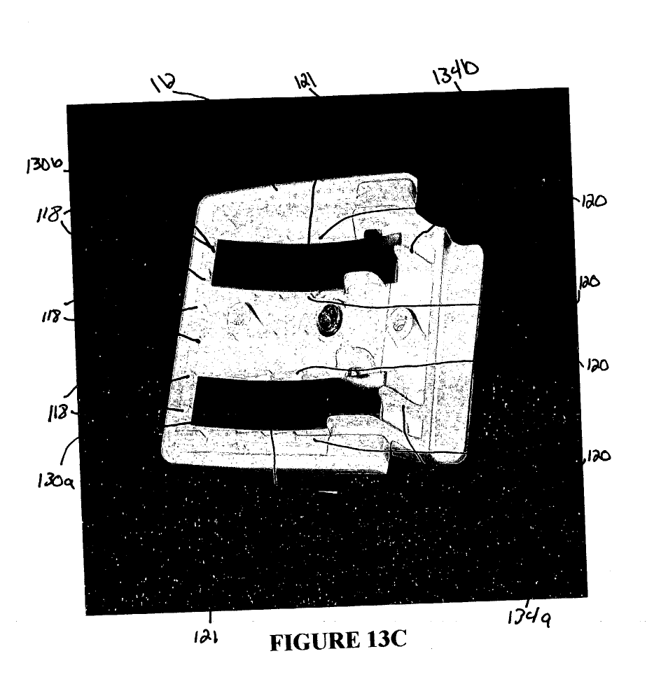

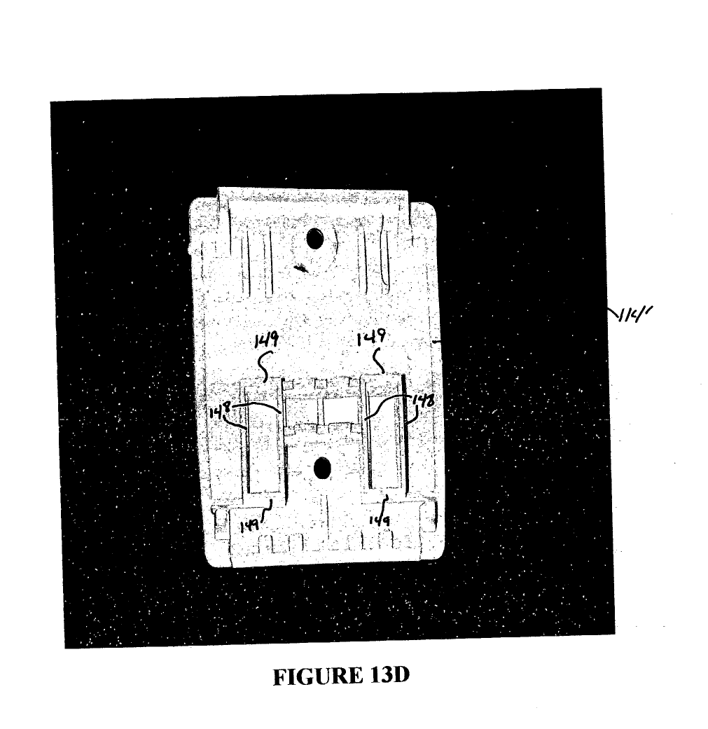

FIGS. 12, 13A and 13B illustrate a gate handle 110 that is used to connect the bi-polar tape to the housing 30 while maintaining electrical continuity across the housing. The gate handle 110 may be utilized in place of the connector 70 and gate handle 78 arrangement described in FIGS. 1-8. A first clamping plate 112, shown in FIG. 13A, of the gate handle 110 cooperates with a second clamping plate 114, shown in FIG. 3B, to clamp the bi-polar tape 34 therebetween whereby the gate handle 110 is securely attached to the end of the tape 34, as well as providing for an electrical connection between the hot and ground wires of the bi-polar tape 34 and the hook 68′ on the housing. Each clamping plate 112, 114 is formed from a non-conducting plastic material. The tape 34 is shown diagrammatically in FIG. 12.

With reference to FIG. 13A, the first clamping plate 112 includes a first end 116 adjacent which there is provided a plurality of ribs 118. Projecting from the interior surface of the plate 112 are a plurality of stepped ribs 120. The ribs 120 generally increase in height as they extend from the first end 116 toward a second, connecting end 122 of the plate 112, with each rib including a series of relatively sharp, pointed tips 124. The plate 12 further includes a trough 132 in which a pair of channels 130a, 130b are formed. A pair of projecting ribs 134a, 134b, each of which has a relatively sharp tip, extends from the interior surface of the plate 112 adjacent the channels 130a, 130b. In addition, an internally threaded boss 136 projects from the interior surface of the plate 112 between the trough 132 and the connecting end 122 and 6 between the ribs 134a, 134b, while an internally threaded boss 137 projects from the interior surface of the plate adjacent the first end 116.

With reference to FIGS. 12 and 13A, the trough 132 forms a channel 138 that opens toward the exterior surface of the plate 112. When the tape 34 is clamped between the plates 112, 114, portions of the tape adjacent the channels 130a, 30b are disposed within the channel 138 so that the tape portions are accessible from outside the gate handle 110. It is the portions of the tape disposed within the channel 38 that are to contact the wires 68a, 68b when the gate handle 110 is connected to the housing. As shown in FIG. 12, the tape 34 preferably includes a hot wire h and a ground wire g that will be located within the channel 138 as discussed above, so that the hot wire h is able to contact the wire 68b, while the ground wire g is able to contact the wire 68a.

With reference to FIG. 13B, the interior surface of the clamping plate 114 that in use faces the interior surface of the clamping plate 112 is visible. A plurality of projections 140 project from the interior surface of the plate 114 adjacent a first end 142 thereof. The projections 140 are sized and shaped to fit between corresponding pairs of the ribs 118 on the plate 112 when the two plates 112, 114 are brought together, thereby helping to firmly clamp the tape 34 between the plates 112, 114.

In addition, a boss 144 having a through hole 146, and a boss 145 having a through hole 147, project from the interior surface of the plate 114 at locations that correspond to the locations of the bosses 136, 137 on the plate 112 when the two plates 12, 114 are secured together. The bosses 136, 144 and 137, 145 cooperate with each other to form a means whereby the two plates 112, 114 are securely fastened together in a releasable manner. Preferably, threaded screws (not illustrated) are used to secure the two plates, with the screws extending through the through holes 146, 147 of the bosses 144, 145 and into threaded engagement with the bosses 136, 137. The screws are preferably inserted through the exterior side of the plate 1114, and the bosses 144, 145 are preferably countersunk on the exterior sides thereof so that the heads of the screws are recessed into the gate handle 110.

Further ribs 148 project from the interior surface of the plate 114, with the ribs 148 positioned to cooperate with the ribs 120 on the plate 112 in a manner to be discussed below. Each rib 148 may also include a relatively sharp, pointed tip 152. The positioning, size and spacing of the ribs 148 are such that when the plates 112, 114 are secured together, each pair of ribs 148 are located between a corresponding pair of ribs 120. As a result, the tape 34 is firmly clamped between the plates 112, 114, with the pointed tips 124, 152 engaging with the tape 34 and helping to prevent the tape 34 from being pulled from the gate handle 110.

As mentioned above and illustrated in FIGS. 12, 13A, 13B and 14, the gate handle 110 is comprised of a first and second clamping plate 112, 114, which are secured together to facilitate the secure attachment of the bi-polar tape 34 to the gate handle 110. Further, in one embodiment of the present invention the clamping plates 112,114 of the gate handle 110 enable the hot and ground wires on the tape 34 to be electrically connected to the hook 68′ on the fence strand assembly housing 30 using contact strips 121 therebetween. The pair of contact strips 121, illustrated in FIG. 13C, are positioned within the pair of first and second clamping plates 112, 114 and work in conjunction with the plates to facilitate a more sturdy and efficient electrical contact surface for the tape 34 to be connected to the loop 68′.

In reference to FIG. 13C, the plates 121 are positioned in the first clamping plate 112, one placed in the channel 130a and the other placed in the channel 130b. The contact plates 121 are preferably thin rectangular plates comprised of aluminum, however another plate shape could be utilized as well as another conductive material. The plates are of a length and width such that they are held in place by the surrounding ribs 134a, 118, 120 in the channel 130a, and by the surrounding ribs 134b, 118, 120 in the channel 130b.

An alternate embodiment of the second connecting plate 114 is illustrated in FIG. 13D. With the contact strips 121 being utilized between the first and second connecting plates 112, 114, the second connecting plate 114′ is modified to include cross members 149 that connect the front and back ends of the two sets of ribs 148 located on the plate 114′. These cross members 149 provide lateral pressure against the tape 34 while the ribs 148 provide longitudinal pressure against the tape 34 to force an overall good contact between the tape 34 and the contact strips 121.

The plate 114 further includes a flange 154 adjacent an end thereof opposite the end 142. The flange 154 cooperates with and is positioned closely adjacent to a wall 156 on the plate 112 when the plates 112, 114 are connected together in order to substantially close off the interior of the gate handle 110 from the exterior thereof.

Returning to FIG. 13A, it is seen that the plate 112 includes a lip 158 at the connecting end 122. In use, the interior surface of the lip 158 rests on one surface of the housing 30, as shown in FIG. 12, while the surface formed by the flange 154 and wall 156 rest on another surface.

After the tape 34 is placed between the two plates 112, 114 and the plates are fastened together, the gate handle 110 is connected to the housing 30 in the following manner. As illustrated in FIG. 12, the connecting end 122 is inserted through the loop 68′. The gate handle 110 is then rotated so that the connecting end 122 engages with the corner of the housing 30. In particular, the interior surface of the lip 158 rests on one corner surface, while the surface formed by the flange 154 and wall 156 rest on another corner surface, thereby achieving a secure connection of the gate handle to the housing.

Further, rotation of the gate handle 110 disposes the loop 68′ and the wires 68a, 68b thereof within the channel 138 of the trough 132, where the wires 68a, 68b contact the ground and hot wires of the tape 34 or the contact strips 121 disposed within the channel 138. Thus, electrical continuity is maintained between the tape 34 that connects to the housing 30, and the tape 34 that exits the housing 30. Disconnection is achieved by rotating the gate handle 110 to an extent that permits the connection end 122 to be removed from the loop 68′.

As mentioned above and illustrated in FIG. 12, the gate handle 110 is used to connect the bi-polar tape 34 to the fence strand assembly housing 30 while maintaining electrical continuity across the housing 30. As also mentioned, in connecting the gate handle 110 to the housing 30, the connecting end is inserted through the loop 68′ and rotated such that the connecting end 122 engages with the housing 30.

In certain alternate embodiments, there is an additional mechanism added to the gate handle 110 to not only ensure and maintain the mechanical connection between the gate handle 110 and the loop 68′ on the housing 30, but also to ensure and maintain a good electrical contact between the tape 34 and/or contact strips 121 and the loop 68′. As illustrated in FIG. 12A, the gate handle 110 further includes a releasable locking latch 69 located on the outer surface of the gate handle 110. The latch 69 is rotatably adjusted such that it can be put in an unlocked or open position (FIG. 12A), as well as a locked or closed position (FIG. 12B).

The latch 69 is generally positioned in a recess 71 on the outer surface of the gate handle 10.

FIGS. 12C and 12D depict the recess 71, located under the bottom end of the latch 69 and one or more locking members 73 positioned on the lower surface of the latch 69. To operably adjoin and lock the gate handle 110 to the housing 30, the gate handle 110 is inserted into the loop 68′ and the latch 69 is rotated such that the locking members 73 secure and press the loop 68′ into secure contact and electrical connection with the tape 34 and/or contact strips 121. The locked latch 69 will be indicated by directing the arrow 75 to the locked symbol 79 (FIG. 12B). Alternatively, to indicate an unlocked latch 69 position, one can simply direct the arrow 75 to the unlocked symbol 77 (FIG. 12A). In one embodiment of the present invention, the latch 69 may be secured to the first clamping plate 112 of the gate handle 110 through the use of a threaded screw and washer (not shown) located on the inner surface of the plate 112.

In connecting the gate handle 110 with the latch 69 to the loop 68′, one must initially open the latch 69 by rotating the latch 69 counterclockwise to its unlocked position, as shown in FIG. 12A. This can be done by rotating the latch 69 until the locking members 73 stop the latch 69 from additional rotation and/or the arrow 75 points in the direction of the unlocked symbol 77. Like previously described, the gate handle 110 can then be inserted through the loop 68′ and rotated such that the connecting end 122 engages with the housing 30. Subsequently, the latch 69 is rotated clockwise to its locked position, as shown in FIG. 12B. This can be done by rotating the latch 69 clockwise until the locking members 73 stop the latch 69 from additional rotation and/or the arrow 75 points in the direction of the locked symbol 79. When the latch 69 is utilized, a mechanical connection can be made between the gate handle 110 and the loop 68′ on the housing 30 that is much more stable and secure than the connection illustrated in FIG. 12. In addition, a good electrical contact between the wires 68a and 68b and the tape 34 and/or contact strips 121 is initiated and sustained through contact pressure applied by the locking members 73, illustrated in FIGS. 12C and 12D, on the wires 68a and 68b.

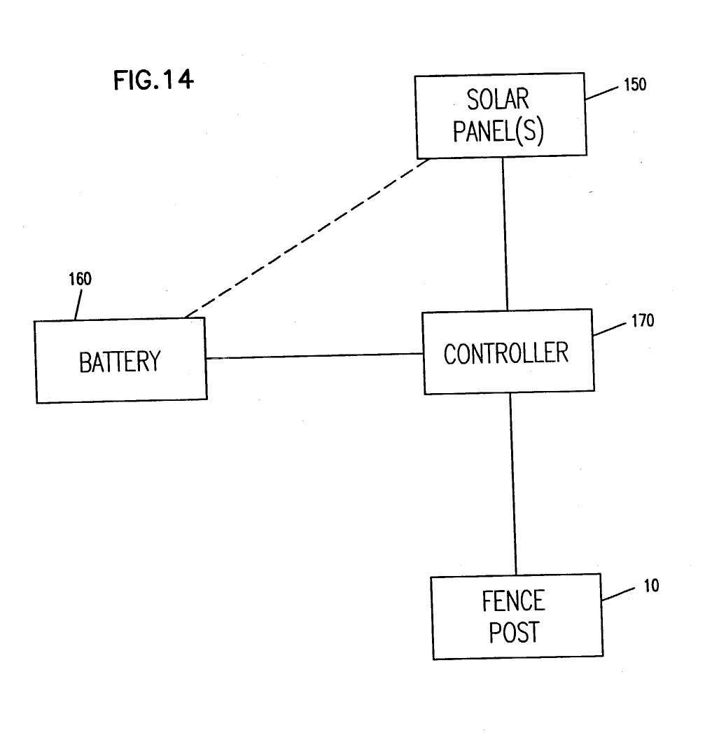

With reference to FIG. 14, in the electric fence version, electricity can be provided by the use of one or more solar panels 150, either mounted on the fence post assembly 10 or provided as a stand alone structure. Alternatively, one or more batteries 160 provided on or in the fence post assembly 10 can be used to provide electrical power. Preferably, the batteries are used in combination with the solar panels, with the solar panels being used to recharge the batteries. A fence controller 170 is provided for controlling operation of the fence post assembly 10. The controller 170 can be mounted in a variety of locations, for example within the fence post 12 or on the exterior thereof, or it can be provided as a stand-alone unit.

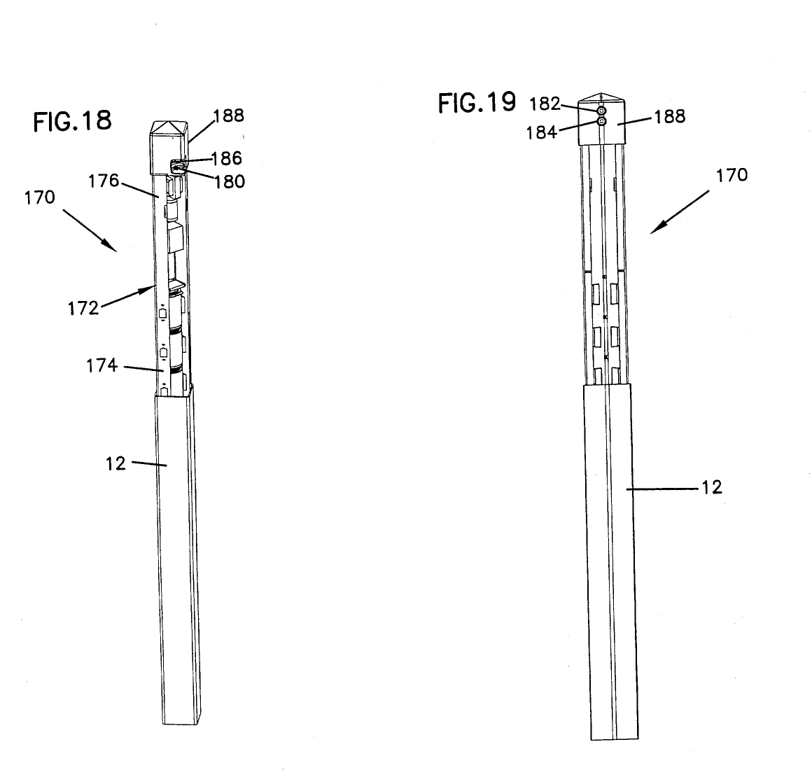

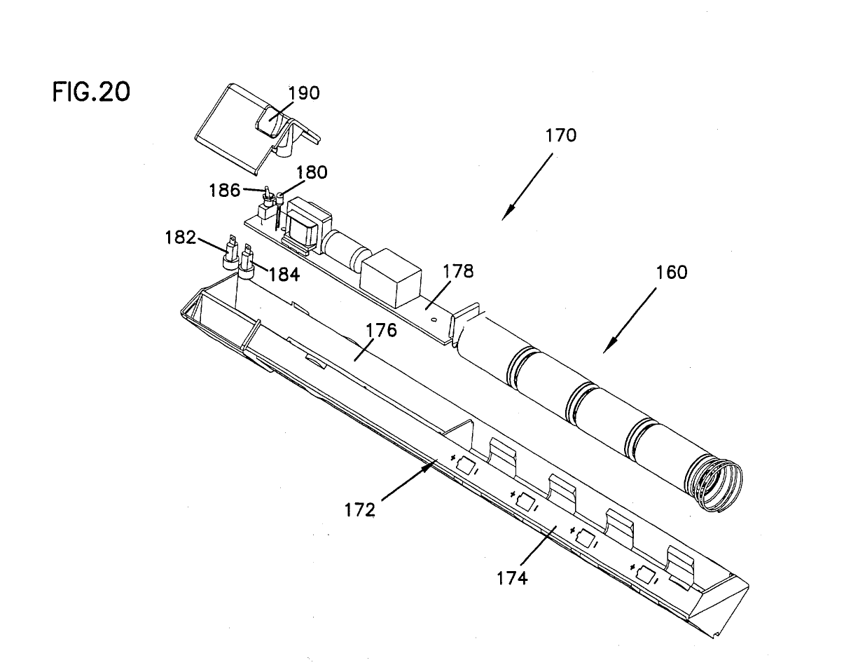

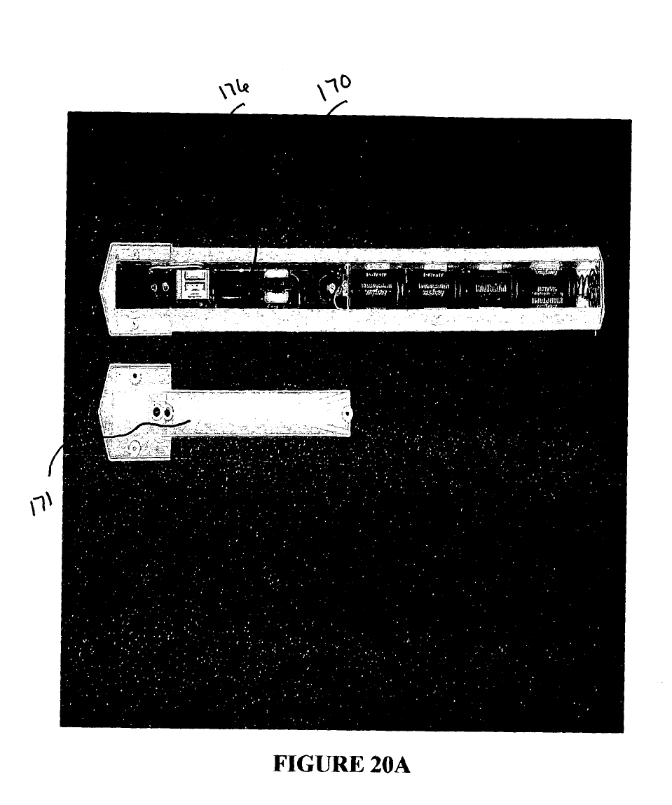

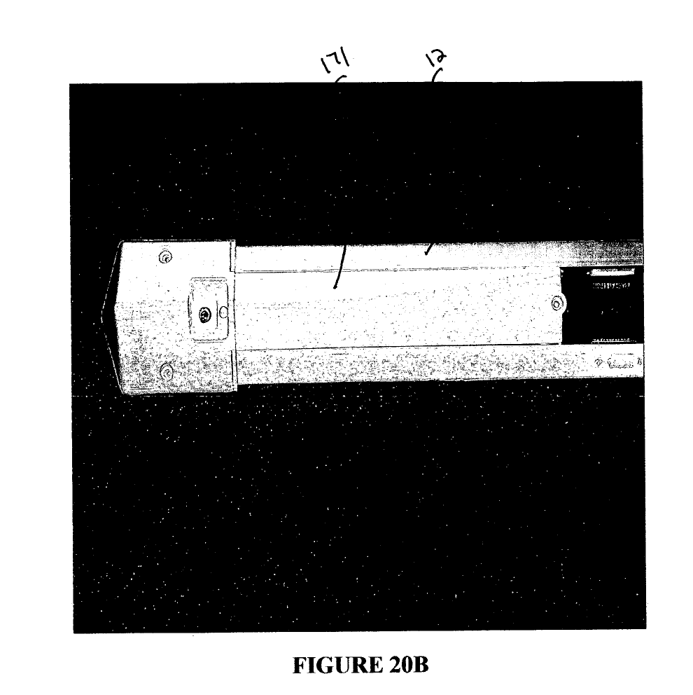

FIGS. 18-20 illustrate a preferred embodiment of the fence controller 170. In this embodiment, the controller 170 is designed to be inserted as a single integral unit into the upper end of the post 12 which must be made hollow to accommodate the controller 170. The controller 170 includes a chassis 172 that has a battery accommodation section 174 and a circuit board section 176, as best seen in FIG. 20. The chassis 172, which is formed from a molded plastic such as polycarbonate, ABS or other engineering grade plastics, has a shape that is similar to the shape of the hollow end of the post 12 to allow the chassis 172 to be inserted into the post as shown in FIGS. 18 and 19. In the preferred embodiment, the chassis 172 is generally triangular in shape which allows the chassis to be inserted into the post 12. The battery section 174 of the chassis 172 is constructed to receive a plurality of batteries 160 for use in powering the controller 170 and/or in providing electricity to the fence strands, as shown in FIG. 20. In the preferred embodiment, four “D” sized batteries 160 are used. However, it is to be realized that a larger or smaller number of batteries, as well as other battery types, could be used, depending upon the power requirements.

Mounted within the circuit board section 176 is a circuit board 178 that contains circuitry for operating the controller 170 and the electric version of the fence post assembly 10. The circuitry on the circuit board is designed to distribute electricity to the electric fence strand member, such as the tape 34 of FIG. 12, to electrify the fence strand member. In addition, the circuitry includes a light 180, such as a light emitting diode (LED), which flashes when the controller is on to indicate that the controller 170 is functioning. A pair of indicator lights 182, 184, one of which is preferably green and the other is preferably red, are also provided in order to provide an indication of the state of the batteries 160. When the batteries 160 have sufficient charge, the green light is illuminated indicating that the battery level is sufficient; on the other hand, when the battery charge is not sufficient, the red light is illuminated to indicate that the batteries need to be recharged or replaced. A switch 186, such as a toggle switch, turns the controller 170 on and off. In use, when the fence strand members are to be electrified, the switch 186 is turned to the “on” position. Once the controller is on, the LED 180 flashes thereby indicating to the user that the controller is operating. In addition, one of the lights 182, 184 will also be illuminated to indicate the condition of the batteries 160.

If desired, the circuitry on the circuit board 178 could also be designed to permit remote operation of the controller. In this case, the circuitry would include equipment, such as a receiver and a transmitter, that could receive remote control commands and transmit information concerning the operation to a remote location.

Referring to FIGS. 18-20, a cap 188 disposed at the upper end of the chassis 172 replaces the cap 90 for closing the end of the post 12. The cap 188 is provided with a cut-out 190 on one side through which the LED 180 is visible and the switch 186 is accessible. In addition, the indicator lights 182, 184 extend through suitable holes in the opposite side of the cap 188 so that the lights 182, 184 are visible, as best seen in FIG. 19.

As mentioned above and illustrated in FIGS. 18-20, the circuit board section 176 is contained on the fence controller 170 and housed within a fence post 12 of the fence post assembly 10. In certain alternate embodiments as depicted in FIGS. 20A and 20B, the fence controller 170 may include a internal cover 171 placed over the circuit board section 176. By doing so, dual protection would be provided for persons handling the fence post assembly 10 in regards to direct exposure to the circuit board section 176.

Normally, the circuit board section 176 is primarily isolated from direct contact with an operator by being housed within the fence post 12. However, with reference to FIG. 20A, an internal cover 171 may be placed and secured over the circuit board section 176 to provide a secondary level of isolation for the operator. The internal cover 171 would isolate the circuit board section 176 from an operator who may separate the controller 170 from the post 12. Such a scenario is likely to occur when the batteries 160 need to be changed, or if there is an electrical malfunction with some of the circuitry in the circuit board section 176. One mode of attachment for the internal cover 171 involves threaded screws being used in one or more holes included in the body of the internal cover 171. The screws are screwed into corresponding bosses on the controller 170. It is contemplated that other mechanisms for securing the internal cover 171 to the circuit board section 176 may be utilized, e.g., through the use of clamps, adhesives and the like, and it is not meant to limit the invention by detailing that the internal cover be secured with threaded screws.

FIG. 9 illustrates four fence post assemblies 10A-D in accordance with the invention that are arranged to form an enclosure 100. An exemplary assembly procedure to form the enclosure 100 is as follows: the four fence post assemblies 10A-D are located at the corners of the enclosure that is to be formed. The anchors, e.g. anchors 16 or 210, are then inserted into the ground, and the posts 12 are then attached to the anchors. The fence strand material 34 is then unwound from the roll of fence post assembly 10A by pulling on the end of the fence strand material and/or by rotating the spool 48 in the appropriate direction. The end of the fence strand material 34 is then connected to the housing on the fence post assembly 10B. A similar procedure is repeated for fence post assemblies 10B-D, with the fence strand material of fence post assembly 10B connecting to fence post assembly 10C, the fence strand material of fence post assembly 10C connecting to fence post assembly 10D, and the fence strand material of fence post assembly 10D connecting to fence post assembly 10A. The housings are adjusted up or down along the posts as needed to provide the desired fence strand height. Although an exemplary procedure for forming the enclosure 100 has been described, other assembly procedures could be used as well.

It should be realized that when the enclosure shown in FIG. 9 is to be electrified, the electrical continuity between the fence strand material of one fence post assembly and the fence strand material of another fence post assembly is maintained in the manner described above. Given the fence construction referenced in FIG. 9, if the fence strand assemblies were energized with a power source, the fence post assemblies of the fence post assemblies 10A, 10B, 10C, 10D would preferably be connected in series with one another. Thus, if one of the corresponding fence strand assemblies malfunctioned or the tape was accidentally cut between two of the assemblies, the electrical continuity of the circuit would also be broken. As previously mentioned, another alternative is to construct a fence having multiple fence strand assemblies on fence post assemblies. By utilizing a fence including multiple fence strand assemblies, one circuit may go out because of an electrical problem involving one fence strand assembly, but the other circuits involving other fence strand assemblies on the post will remain energized and provide a fence that is still energized.

Instead of using four fence post assemblies 10A-D, a larger or smaller number of fence post assemblies could be used to form the enclosure. For instance, if sufficient quantity of fence strand material 34 is available on the roll, the enclosure could be formed by running the material 34 from the housing of one fence post assembly 10, around man-made objects such as fence posts that do not have fence strand material rolls and housings as described herein, or around natural objects such as trees, and back to the original fence post assembly where it would connect to the housing. This type of enclosure using a fence post assembly with a single housing is particularly useful when the fence strand material that is used is wire, as the length of wire that can be used on a spool is much greater than the length of tape that can be used on the spool.

In addition, one or more of the fence post assemblies could be used in combination with existing structure(s) to form the enclosure. For instance, one or more fence post assemblies 10 could be used in combination with a side wall of a building or vehicle structure to form the enclosure. Moreover, the end of the fence strand material 34 could be connected to the structure, rather than to an adjacent fence post assembly.

Each fence post assembly can be provided individually or as part of a kit along with one or more additional fence post assemblies. Moreover, the components of the fence post assembly 10, including the fence strand assembly 14, the fence post 12 and the ground anchor 16, can be provided as separate elements, thereby permitting replacement of one of the components in the event that a component should break, fail or otherwise need replacement.

To provide added stability to the fence post assembly 10, a guy wire 200 can extend from a portion of the fence post assembly 10 with the opposite end of the guy wire 200 anchored to the ground. As an example, as shown in FIG. 1, the guy wire 200 can connect to the clamp assembly 82.

It is to be understood that while certain embodiments of the present invention have been illustrated and described, the invention is not limited to the specific forms or arrangements of parts described and shown. Rather, the invention is defined by the following claims.

We claim:

1. A fence post assembly, comprising:
a post having first and second opposite ends;
a ground anchor connected to the post adjacent the first end for anchoring the post; and
one or more fence strand assembly connected to the post, said fence strand assembly includes an electrically conductive extendable and retractable fence strand operably adjoined to an at least partially electrically conductive strand connector for removably securing the extendable and retractable fence strand to another object, and said extendable and retractable fence strand is selectively positionable along the length of the post between the first and second opposite ends thereof.

2. The fence post assembly according to claim 1, wherein said extendable and retractable fence strand is at least partially disposed within a housing, and said housing is selectively positionable along the length of the post between the first and second opposite ends thereof.

3. The fence post assembly according to claim 1, wherein said extendable and retractable fence strand is connected to a spindle, and further including a spool connected to the spindle for rotating the spindle.

4. The fence post assembly according to claim 3, further including a crank handle connected to the spool.

5. The fence post assembly according to claim 4, wherein the crank handle includes an interlocking cover which spins when the crank handle is rotated.

6. The fence post assembly according to claim 2, wherein said housing includes a clamp assembly connected thereto, said clamp assembly is in releasable clamping engagement with the post.

7. The fence post assembly according to claim 1, wherein said strand connector is a gate handle operably connected to the end of the fence strand.

8. The fence post assembly according to claim 7, wherein said gate handle includes a releasable locking latch.

9. The fence post assembly according to claim 2, wherein said housing includes a lock lever associated therewith, said lock lever is selectively engageable with said extendable and retractable fence strand to control extension and retraction of the fence strand from the housing.

10. The fence post assembly according to claim 9 wherein said lock lever includes a clamp bar having a plurality of projections.

11. The fence post assembly according to claim 9, wherein the lock lever is pivotable relative to the housing between a first locking position and a second unlocked position.

12. The fence post assembly according to claim 9, wherein the lock lever includes a scalloped depression.

13. The fence post assembly according to claim 2, further including a wire connected to the housing, the wire includes a first end in the form of a loop and a second end positioned on an opposite side of the housing from the first end.

14. The fence post assembly according to claim 1, further including a power source that provides electrical energy to the fence strand, and a controller that controls the electrical energy provided to the fence strand.

15. The fence post assembly according to claim 14, wherein the power source includes one or more solar panels, batteries or a combination thereof.

16. The fence post assembly according to claim 14, wherein the power source and controller are positioned on or within the post.

17. An electric portable fencing system for forming an enclosure, comprising:
at least one fence post assembly, the at least one fence post assembly including:
a post having first and second opposite ends;
a ground anchor connected to the post adjacent the first end for anchoring the post; and
one or more fence strand assembly connected to the post, said fence strand assembly includes an electrically conductive extendable and retractable fence strand operably adjoined to an at least partially electrically conductive strand connector for removably securing the extendable and retractable fence strand to another object, and said extendable and retractable fence strand is selectively positionable along the length of the post between the first and second opposite ends thereof.

18. The electric portable fencing system according to claim 17, including a plurality of said fence post assemblies.

19. The electric portable fencing system according to claim 17, wherein the extendable and retractable fence strand of one of said fence post assemblies has a length that is sufficient to connect to an adjacent fence post.

20. The electric portable fencing system according to claim 17, wherein said extendable and retractable fence strand is at least partially disposed within a housing, and said housing is selectively positionable along the length of the post between the first and second opposite ends thereof.

21. The electric portable fencing system according to claim 17, wherein said extendable and retractable fence strand is connected to a spindle, and further including a spool connected to the spindle for rotating the spindle.

22. The electric portable fencing system according to claim 21, further including a crank handle connected to the spool.

23. The electric portable fencing system according to claim 22, wherein the crank handle includes an interlocking cover which spins when the crank handle is rotated.

24. The electric portable fencing system according to claim 17, wherein said strand connector is a gate handle operably connected to the end of the fence strand.

25. The electric portable fencing system according to claim 24, wherein said gate handle includes a releasable locking latch.

26. The electric portable fencing system according to claim 20, wherein said housing includes a lock lever associated therewith, said lock lever is selectively engageable with said extendable and retractable fence strand to control extension and retraction of the fence strand from the housing.

27. The electric portable fencing system according to claim 26 wherein said lock lever includes a clamp bar having a plurality of projections.

28. The electric portable fencing system according to claim 26, wherein the lock lever includes a scalloped depression.

29. The electric portable fencing system according to claim 17, further including a power source that provides electrical energy to the fence strand, and a controller that controls the electrical energy provided to the fence strand.

30. The electric portable fencing system according to claim 29, wherein the power source includes one or more solar panels, batteries or a combination thereof.

31. The electric portable fencing system according to claim 29, wherein the power source and controller are positioned on or within one or more of the posts.

32. A method of forming an enclosure, including the steps of:
providing a first fence post assembly having a post having first and second opposite ends;
a ground anchor connected to the post adjacent the first end for anchoring the post; and one or more fence strand assembly connected to the post, said fence strand assembly includes an electrically conductive extendable and retractable fence strand operably adjoined to an at least partially electrically conductive strand connector for removably securing the extendable and retractable fence strand to another object, and said extendable and retractable fence strand is selectively positionable along the length of the post between the first and second opposite ends thereof;
anchoring the post to the ground;
extending the fence strand a sufficient amount to at least partially form an enclosure; and
positioning the fence strand along the length of the post to achieve the desired fence strand height.

33. The method according to claim 32, further including:
providing at least one additional post; and
using the at least one additional post and said first fence post assembly to form the enclosure.

34 The method according to claim 32, wherein said extendable and retractable fence strand is connected to a spindle, and further including a spool connected to the spindle for rotating the spindle.

35. The method according to claim 32, wherein the spool further includes a crank handle.

36. The method according to claim 35, wherein the crank handle includes an interlocking cover which spins when the crank handle is rotated.

37. The method according to claim 32, wherein said strand connector is a gate handle operably connected to the end of the fence strand.

38. The method according to claim 37, wherein said gate handle includes a releasable locking latch.

39. The method according to claim 32, wherein the fence post assembly includes a housing having a lock lever associated therewith, said lock lever is selectively engageable with said extendable and retractable fence strand to control extension and retraction of the fence strand from the housing.

40. The method according to claim 39, wherein said lock lever includes a clamp bar having a plurality of projections.

41. The method according to claim 39, wherein the lock lever is pivotable relative to the housing between a first locking position and a second unlocked position.

42. The method according to claim 39, wherein the lock lever includes a scalloped depression.

43. The method according to claim 32, wherein the fence post assembly further includes a power source that provides electrical energy to the fence strand, and a controller that controls the electrical energy provided to the fence strand.

44. The method according to claim 43, wherein the power source includes one or more solar panels, batteries or a combination thereof.

45. The method according to claim 43, wherein the power source and controller are positioned on or within the post.
